(19) United States
(12) Patent Application Publication
(10) Pub. No.: US 2026/0102308 A1
(43) Pub. Date: Apr. 16, 2026

(54) Exoskeletons with Power Actuators and Methods of Operation Thereof

(71) Applicant: suitX, Inc., Emeryville, CA (US)

(72) Inventors: Wayne Yi-Wei Tung, Emeryville, CA (US); Minerva Pillai, Redwood City, CA (US); Michael McKinley, Berkeley, CA (US); John Kuwata, El Cerrito, CA (US); Yi Zeng, Emeryville, CA (US); Zhendong Liu, Emeryville, CA (US); Jason Huang, Emeryville, CA (US); Samuel Reimer, Emeryville, CA (US); Logan Van Engelhoven, Emeryville, CA (US); Homayoon Kazerooni, Berkeley, CA (US); Markus Tüttemann, Duderstadt (DE); Fabienne Röschel, Duderstadt (DE); Oliver Mizera, Goettingen (DE); Maximiliam Merker, Goettingen (DE); Pascal Schwedhelm, Duderstadt (DE); Christian Müller, Duderstadt (DE); Jose González, Duderstadt (DE); Mario Koppe, Duderstadt (DE); Jonas Bornmann, Duderstadt (DE); Markus Mladek, Duderstadt (DE); Carsten Vogel, Duderstadt (DE)

(21) Appl. No.: 19/416,951

(22) Filed: Dec. 11, 2025

Related U.S. Application Data
(63) Continuation of application No. PCT/US2025/050545, filed on Oct. 10, 2025.
(60) Provisional application No. 63/706,385, filed on Oct. 11, 2024.

(51) Int. Cl. A61H 3/00; A61H 1/02; B25J 9/00

(52) U.S. Cl. CPC A61H 3/00; A61H 1/0237; A61H 1/0292; B25J 9/0006; A61H 2201/1445; A61H 2201/165; A61H 2201/5007; A61H 2201/5053

(57) ABSTRACT

An exoskeleton is configured to reduce muscle forces in a user's back during forward lumbar flexion. The exoskeleton includes a frame coupled to the user's trunk, a first link coupled to a first thigh and rotatably connected to the frame, and a second link coupled to a second thigh and rotatably connected to the frame. An actuator coupled to the frame includes a first element and a second element that rotate or translate relative to each other to generate a force or torque transmitted through lines connected to the thigh links. A lockout mechanism selectively couples components of the exoskeleton to restrict rotation of the first link relative to the frame in at least one direction, providing controlled support during flexion while permitting free movement during other activities.

### CROSS-REFERENCE TO RELATED APPLICATIONS

This application is a continuation of PCT Application No. PCT/US25/50545, filed on 2025 Oct. 10, which claims the benefit under 35 U.S.C. § 119(e) of U.S. Provisional Patent Application 63/706,385, filed on 2024 Oct. 11, both of which are incorporated herein by reference in their entirety for all purposes.

### FIELD OF TECHNOLOGY

The present disclosure pertains to the art of exoskeletons to support the human body, particularly to exoskeletons configured to reduce the bending moment on a person's back during a forward bend.

### BACKGROUND

Exoskeletons are used to assist people in bending, standing upright, or any combination of these movements. Conventional exoskeletons are designed such that a supportive torque is created during a bend to counteract the torques from a person's trunk gravity weight. The exoskeleton is designed such that it acts about the person's hip or lower back to reduce the probability of injury to the spine. Exoskeletons may utilize passive spring resistance or active motor resistance to create a torque between the person's trunk and legs. Exoskeletons may utilize a rigid frame with defined rotation axes or a flexible interface to apply the supportive torque to the person.

The present disclosure also relates to exoskeletons or wearable devices in general, as many of the described embodiments can apply to supporting various body parts and motions other than the examples given.

### SUMMARY

The present disclosure is directed to an exoskeleton, which is configured to be worn by a person to reduce the muscle forces in the person's back during forward lumbar flexion. The exoskeleton comprises a frame that transfers weight or supporting forces and torques to the person. The exoskeleton generally encompasses a frame configured to be attached to the trunk of a person, two links configured to be attached to the right and left thighs of a person, and a hip joint allowing the links to move or rotate relative to the frame. An actuator is configured to apply a torque about the hip joint, the actuator comprising a means for creating a force or torque that is distributed through the frame and links to support a motion of the person. The frame is attached to the person with a human-machine interface. The human machine interface comprises the strapping, padding, cuffs, etc, that comfortably transfer the weights, forces, and torques from the exoskeleton frame to the body of the person.

An exoskeleton can be used to reduce muscle forces in a person's back during lumbar flexion, which occurs during maneuvers such as stooping and bending. A person may wish to wear an exoskeleton to provide support during these activities and continue wearing the exoskeleton (e.g., for convenience) during other activities, including walking, ascending a slope, or climbing stairs or a ladder. Some examples provide an exoskeleton that reduces muscle forces in a person's back during stooping and bending while also allowing the person to comfortably walk, ascend a slope, or climb stairs or a ladder.

In some embodiments, the exoskeleton includes a supporting frame, first and second links, and an actuator that produces an extension torque between the links and frame to provide support to the person during stooping or bending.

In some embodiments, the actuator produces an extension torque between the first and second links and the frame only when the person is bent forward in a sagittal plane. In some embodiments, the actuator does not produce an extension torque between the first and second links and the frame when a user is walking, ascending, or climbing.

In some embodiments, the actuator generates a force or torque between a first element of the actuator and a second element of the actuator, which in turn produces an extension torque between the links and frame. In some embodiments, the torque generated by the actuator between the first element and the second element is transferred through a system of pulleys and lines to generate the extension torque between the links and frame.

In some embodiments, the first element and second element can rotate relative to each other (e.g., in response to non-reciprocal motion of thigh links coupled to the actuator housing and actuator shaft, which occurs, e.g., when a person's legs do not move in opposite directions at the same speed). Non-reciprocal motion occurs naturally during activities such as walking, ascending, and climbing. For example, during some phases of a walking gait cycle, both legs of a person move in the same direction.

In some embodiments, motion of the first and second links relative to the frame (e.g., while a person walks while wearing the exoskeleton) can transmit forces through a system of lines and pulleys to the first element and second element. In embodiments in which the first element and second element can rotate relative to each other, these forces can cause the first element and second element to rotate relative to each other when the forces are not equal and opposite (i.e., in response to non-reciprocal motion of the thigh links which occurs, for example when a person's legs do not move in opposite directions at the same speed). Allowing the first element and second element to rotate relative to each other in response to non-reciprocal motion of the thigh links can allow a person to feel more comfortable when walking, ascending, or climbing while wearing the exoskeleton. If the first element and second element could not be rotated relative to each other in response to non-reciprocal motion of the thigh links, tensile forces in the lines connecting the actuator housing and actuator shaft to the first and second links could resist the non-reciprocal motion, making walking, ascending, or climbing uncomfortable or impossible for the user.

In some embodiments, the actuator can rotate relative to the frame (e.g., in response to non-reciprocal motion of thigh links coupled to the actuator housing and actuator shaft).

Allowing the actuator to rotate or translate relative to the frame in response to reciprocal motion of the thigh links can allow a person to feel more comfortable when walking, ascending, or climbing while wearing the exoskeleton. If the actuator could not be rotated relative to the frame in response to reciprocal motion of the links, tensile forces in the lines connecting the first element and second element to the first and second links could resist the motion, making walking, ascending, or climbing uncomfortable or impossible for the user.

Clause 1. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200; the first link 104 rotatably coupled to the frame 102, a second link 106 configured to be coupled to a second thigh of the person 200, the second link 106 is rotatably coupled to the frame 102; an actuator 440 coupled to the frame 102, wherein the actuator 440 comprises: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106; and a lockout mechanism 550 configured to selectively couple two components of exoskeleton 100 such that the first link 104 is prevented from rotating relative to the frame 102 in at least one direction, wherein: when the lockout mechanism 550 is in an unlocked position, the lockout mechanism 550 does not influence motion of the first link 104 relative to the frame 102, and when the lockout mechanism 550 is in a locked position, the first link 104 is prevented from flexing relative to the frame 102.

Clause 2. The exoskeleton of clause 1, wherein the lockout mechanism 550 is configured to selectively couple the first element 442 to the second element 444 such that the first link 104 and the second link 106 are prevented from rotating relative to the frame 102 in at least one direction when the lockout mechanism 550 is in a locked state.

Clause 3. The exoskeleton of clause 1 wherein: the first element 442 further comprises a first pulley 446 coupled to the first end 452 of the first line 450, the second element 444 further comprises a second pulley 448 coupled to the first end 458 of the second line 456, and the lockout mechanism 550 is configured to selectively couple the first pulley 446 to the second pulley 448 such that the first link 104 and the second link 106 is prevented from rotating relative to the frame 102 in at least one direction when the lockout mechanism 550 is in a locked state.

Clause 4. The exoskeleton of clause 3, further comprising a clutch 580 coupled between the actuator 440 and the frame 102, the clutch 580 configured to enter an engaged position and a disengaged position; wherein: when the clutch 580 is in an engaged position, the actuator 440 is coupled to the frame 102 such that when the lockout mechanism 550 is in the locked position neither the first link 104 nor the second link 106 can rotate relative to the frame 102 in a flexion direction, and when the clutch 580 is in a disengaged position, the actuator 440 is rotatable relative to the frame 102, such that when the lockout mechanism 550 is in the locked position, the first link 104 is able to move in a reciprocal motion relative to the second link 106 without a change in position of the first element 442 relative to the second element 444.

Clause 5. The exoskeleton 100 of clause 1 further comprising: a first-link pulley 108 configured to be coupled to or move proportionally with the first link 104, and a second-link pulley 110 configured to be coupled to or move proportionally with the second link 106, wherein: the first-line second end 454 is coupled to the first-link pulley 108 and the second-line second end 460 is coupled to the second-link pulley, and the lockout mechanism 550 is configured to selectively couple the frame 102 to one or a combination of the first line 450, first link 104, the first pulley 446, or the first-link pulley 108.

Clause 6. The exoskeleton 100 of clause 5, further comprising an additional lockout mechanism 551 configured to selectively couple the frame 102 to one or a combination of the second line 456, second link 106, the second pulley 448, or the second-link pulley 110 such that the second link 106 is prevented from rotating relative to the frame 102 in at least one direction, wherein: when the additional lockout mechanism 551 is in an unlocked position, the additional lockout mechanism 551 does not influence motion of the second link 106 relative to the frame 102, and when the additional lockout mechanism 551 is in a locked position, the second link 106 is prevented from flexing relative to the frame 102.

Clause 7. The exoskeleton 100 of clause 6, wherein: the lockout mechanism 550 is configured to couple the frame 102 to the first line 450, and the additional lockout mechanism 551 is configured to couple the frame 102 to the second line 456.

Clause 8. The exoskeleton 100 of clause 6, wherein: the lockout mechanism 550 is configured to couple the frame 102 to the first link 104, and the additional lockout mechanism 551 is configured to couple the frame 102 to the second link 106.

Clause 9. The exoskeleton 100 of clause 1, wherein when the lockout mechanism 550 is in the locked position, the lockout mechanism 550 prevents the first link 104 from flexing and extending relative to the frame 102.

Clause 10. The exoskeleton 100 of clause 1, wherein when the lockout mechanism is in the locked position, the lockout mechanism 550 prevents the first link 104 from flexing relative to the frame 102 while allowing for free extension of the first link 104 relative to the frame 102.

Clause 11. The exoskeleton 100 of clause 1, wherein the lockout mechanism 550 is configured to support person 200 in a sustained bent posture without use of a supporting torque 222 generated by the actuator 440.

Clause 12. An exoskeleton 100 of clause 1, comprising a control system 1100 configured to command the lockout mechanism 550 into a locking state.

Clause 13. The exoskeleton 100 of clause 10, wherein the lockout mechanism 550 is actuated by a solenoid.

Clause 14. The exoskeleton 100 of clause 10, wherein the lockout mechanism 550 is configured to enter a locked position when the person 200 has remained in a bent posture for longer than a specified duration of time.

Clause 15. The exoskeleton of clause 1, further comprising a passive element 560 configured to act in series or parallel with the actuator 440 to provide a quicker response of a supporting torque 222 to the person 200, add compliance to the exoskeleton 100, to alter or reduce actuator 440 torque output requirements, to improve force control, to impact absorption, to dissipate, store or release energy, or to act as a mechanical force filter, wherein: when the person 200 is in a forward bent position and the lockout mechanism 550 is in an unlocked position, the actuator 440 and the passive element 560 generate a force or torque between the first element 442 and the second element 444, thereby generating a supportive torque 222 between the first and the second links 106 and the frame 102 that reduces muscle forces in the back of the person 200, and when the person 200 is in a forward bent position and the lockout mechanism 550 is in an locked position, only the passive element 560 generates a force or torque between the first element 442 and the second element 444, thereby generating a supportive torque 222 between the first and the second links 106 and the frame 102 that reduces muscle forces in the back of the person 200.

Clause 16. The exoskeleton 100 of clause 15, wherein the passive element 560 may contain springs or dampers and allow for on/off selective engagement, force adjustment, set engagement position, and engagement position adjustment.

Clause 17. The exoskeleton of clause 1, wherein the frame 102 further comprises: a center subframe 510 configured to sit near a center of a body; a first subframe 512 rotatably coupled to the center subframe 510 about a differential axis 660 and configured to sit along a right of the body; and a second subframe 514 rotatably coupled to the center subframe 510 about the differential axis 660 such that its rotation relative to the center subframe 510 is opposite to the rotation of the first subframe relative to the center subframe 510 in a reciprocal manner, the second subframe 514 configured to sit along a left of the body, wherein: when the person 200 bends forward, the first subframe 512 and the second subframe 514 are prevented from rotating in a same direction relative to the center subframe 510 about the differential axis 660, such that any motion of the person comes through the motion of the first link 104 or the second link 106 rotating relative to the frame 102, and when the person 200 walks, the first subframe 512 and the first thigh link 104 rotate reciprocally relative to second subframe 514 and the second thigh link 106 about the differential axis 660, regardless of a state of the actuator 440 or the lockout mechanism 550, thereby allowing the person 200 to walk freely.

Clause 18. The exoskeleton 100 of clause 17, wherein the differential axis 660 is substantially colinear with a rotation axis 608 between the first link 104 and the frame 102.

Clause 19. The exoskeleton 100 of clause 17, wherein the axis 608 is approximately colinear with a hip joint of the person.

Clause 20. The exoskeleton 100 of clause 1, wherein the lockout mechanism 550 is actuated manually.

Clause 21. The exoskeleton 100 of clause 1, wherein the lockout mechanism 550 is spring-loaded into a locked or an unlocked position.

Clause 22. The exoskeleton 100 of clause 1, wherein the lockout mechanism 550 comprises one or more selected from the group consisting of a ratchet, a tooth, a pin, a clamp, a brake, a cleat, a one-way bearing, and a lockable pulley.

Clause 23. The exoskeleton of clause 12, wherein the control system comprises inputs 1102 of temperature of the actuator 440 to trigger a locked state of the lockout mechanism 550.

Clause 24. The exoskeleton of clause 12, wherein the control system comprises inputs 1102 of a battery discharge rate to trigger a locked state of the lockout mechanism 550.

Clause 25. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102; a second link 106 configured to be coupled to a second thigh of the person 200, wherein the second link 106 is rotatably coupled to the frame 102; a first-link pulley configured to be coupled to or move proportionally with the first link; a second-link pulley configured to be coupled to or move proportionally with the second link; an actuator 440 coupled to the frame 102, wherein the actuator 440 comprises: a first element 442 and a second element 444, wherein the first element 442 and the second element 444 are configured to rotate or translate relative to each other to create a force or torque, a first line 450 having a first-line first end 452 coupled to the first element 442 and a first-line second end 454 coupled to the first link pulley 108, and a second line 456 having a second-line first end 458 coupled to the second element 444 and a second-line second end 460 coupled to the second link pulley 110; and a lockout mechanism 550 configured to selectively couple the frame 102 to one or a combination of the first line 450, first link 104, the first pulley 446, or the first-link pulley 108 such that the first link 104 is prevented from rotating relative to the frame 102 in at least one direction, wherein: when the lockout mechanism 550 is in an unlocked position, the lockout mechanism 550 does not influence motion of the first link 104 relative to the frame 102, and when the lockout mechanism 550 is in a locked position, the first link 104 is prevented from flexing relative to the frame 102.

Clause 26. An exoskeleton 100 for reducing muscle forces in a back of a person 200 during forward lumbar flexion, the exoskeleton 100 comprising: a frame 102 configured to be coupled to a trunk of the person 200, the frame 102 comprising: a center subframe 510 configured to sit near a center of a body of the person 200, a first subframe 512 adjustably coupled to the center subframe 510 and configured to sit along a first part of the body of the person 200, a second subframe 514 adjustably coupled to the center subframe 510 and configured to sit along a second part of the body of the person 200, a first adjustment switch 516 configured to selectively adjust and fix a position of the first subframe 512 relative to the center subframe 510 along a frame adjustment direction 518, and a second adjustment switch 516 configured to selectively adjust and fix the position of the second subframe 514 relative to the center subframe 510 along the frame adjustment direction 518; a first link 104 configured to be coupled to a first thigh of the person 200, the first link 104 rotatably coupled to the first subframe 512; a second link 106 configured to be coupled to a second thigh of the person 200, the second link 106 rotatably coupled to the second subframe 514; an actuator 440 coupled to the frame 102, wherein the actuator comprises: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106; a first jacket 470 coupled between the center subframe 510 and the first subframe 512, the first jacket 470 configured to envelop the first line 450 to route tensile forces in the first line 450; a second jacket 472 coupled between the center subframe 510 and the second subframe 514, the second jacket 472 configured to envelop the second line 456 to route tensile forces in the second line 456; and a jacket adjustment mechanism 570 configured to adjust and fix position of the first jacket 470 or the second jacket 472 relative to the frame 102 to accommodate for adjustments in the first subframe 512 or the second subframe 514 relative to the center subframe 510.

Clause 27. The exoskeleton 100 of clause 26, wherein the frame adjustment direction 518 corresponds to one or more selected from the group consisting of a width of the person 200, a height of the person 200, and a depth of the trunk of the person 200.

Clause 28. The exoskeleton 100 of clause 26, wherein: the first jacket 470 is incompressible along the first line 450, and the second jacket 472 is incompressible along the second line 456.

Clause 29. The exoskeleton 100 of clause 26, wherein the jacket adjustment mechanism 570 is configured to switch between: a locked position, in which the jacket 470 is prevented from moving relative to the frame 102, and an unlocked position, in which the jacket 470 is movable relative to the frame 102.

Clause 30. The exoskeleton 100 of clause 26, wherein the jacket adjustment mechanism 570 is configured to transfer compressive forces from the jacket 470 to the frame 102.

Clause 31. The exoskeleton 100 of claim 26, wherein the jacket adjustment mechanism 570 is configured to adjust the jacket 470 in a linear direction relative to the center subframe 510, the right side of the frame 102, or the left side of the frame 102.

Clause 32. The exoskeleton 100 of clause 26, wherein the jacket adjustment mechanism 570 comprises one or more selected from the group consisting of a pin and a hole, a screw, a clamp, a ratchet, or a slot and spring-loaded button mechanism.

Clause 33. The exoskeleton 100 of clause 26 further comprising a line adjustment mechanism 590 configured to adjust a connection point between the first line 450 and the first element 442 or the first link 104.

Clause 34. The exoskeleton 100 of clause 33, wherein the line adjustment mechanism 590 is a clamp that continually adjusts the position of the first line 450.

Clause 35. The exoskeleton 100 of clause 33, wherein the line adjustment mechanism 590 comprises a ratchet and pawl mechanism.

Clause 36. The exoskeleton 100 of clause 26, wherein the actuator 440 further comprises: a first pulley 446 configured to be coupled to or move proportionally with the first element 442; and a second pulley 448 configured to be coupled to or move proportionally with the second element 444, wherein: the first-line first end 452 is coupled to the first pulley 446, second-line first end 458 is coupled to the second pulley 448, and the jacket adjustment mechanism 570 is configured to rotate or translate along a circular path 682 relative to the frame 102 corresponding to the rotation of the first pulley 446 or the second pulley 448.

Clause 37. The exoskeleton 100 of clause 36, wherein the jacket adjustment mechanism 570 is configured to attach to the first jacket 470 in an orientation tangent to the first pulley 446 or the second pulley 448 such that the position of the jacket adjustment mechanism 570 is not affected by tensile forces in the first line 450 or the second line 456 or corresponding compressive forces in the first jacket 470.

Clause 38. The exoskeleton 100 of clause 26, wherein the jacket adjustment mechanism 570 is configured to move or rotate to a position that minimizes the bend radius or cumulative bend radius of the first jacket 470.

Clause 39. The exoskeleton 100 of clause 26 further comprising: a first-link pulley 108 configured to be coupled to or move proportionally with the first link 104, and a second-link pulley 110 configured to be coupled to or move proportionally with the second link 106, wherein: the first-line second end 454 is coupled to the first-link pulley 108, and the second-line second end 460 is coupled to the second-link pulley 110, and the jacket adjustment mechanism 570 is configured to rotate or translate along a circular path 682 relative to the frame 102 corresponding to a rotation axis 608 of the first-link pulley 108 or the second-link pulley 110.

Clause 40. The exoskeleton 100 of clause 39, wherein the jacket adjustment mechanism 570 is configured to move or rotate to a position that minimizes the bend radius or cumulative bend radius of the first jacket 470.

Clause 41. The exoskeleton 100 of clause 39, wherein the jacket adjustment mechanism 570 is configured to attach to the first jacket 470 in an orientation tangent to the first-link pulley 108 or the second-link pulley 110 such that the position of the jacket adjustment mechanism 570 is not affected by tensile forces in the first line 450 or the second line 456 or corresponding compressive forces in the jacket 470.

Clause 42. The exoskeleton 100 of clause 39 further comprising an additional jacket adjustment mechanism 570 configured to adjust and fix position of the second jacket 472 relative to the frame 102 to accommodate adjustments in the second subframe 514 relative to the center subframe 510.

Clause 43. An exoskeleton 100 for reducing muscle forces in a back of the person 200 during forward lumbar flexion, the exoskeleton 100 comprising: a frame 102 configured to be coupled to a trunk of the person 200; a first link 104 configured to be coupled to a first thigh of the person 200; the first link 104 rotatably coupled to the frame 102, a second link 106 configured to be coupled to a second thigh of the person 200, the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106, and a line adjustment mechanism 590 configured to adjust a position of an attachment point of the first line 450 to the first pulley 446 or the first link 104.

Clause 44. An exoskeleton 100 for reducing muscle forces in a back of the person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102; a second link 106 configured to be coupled to a second thigh of the person 200, wherein the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106; and a passive element 560 configured to act in series or parallel with the actuator to provide a quicker response of the supporting torque to the person 200, add compliance to the exoskeleton 100, to alter or reduce actuator 440 torque output requirements, to improve force control or impact absorption, to dissipate, store or release energy, or to act as a mechanical force filter, wherein: when the person 200 is in a forward bent position, the actuator 440 and the passive element 560 generate a force or torque between the first element 442 and the second element 444, thereby generating a supportive torque 222 between the first and the second links 106 and the frame 102 that reduces muscle forces in the back of the person 200.

Clause 45. The exoskeleton 100 of clause 44, wherein the passive element 560 may contain springs or dampers and allow for on/off selective engagement, force adjustment, set engagement position, and engagement position adjustment.

Clause 46. The exoskeleton 100 of clause 44 further comprising: a first jacket 470 coupled to the trunk frame 102 from both ends, the first jacket 470 configured to envelop the first line 450 to route tensile forces in the first line 450 between two locations on the trunk frame 102 while reducing friction forces, and a second jacket 472 coupled to the trunk frame 102 from both ends, the second jacket 472 configured to envelop the second line 456 to route tensile forces in the second line 456 between two locations on the trunk frame 102 while reducing friction forces, wherein the passive element 560 is coupled to the trunk frame 102 from its first end and to the first jacket 470 or the second jacket 472 from its second end 454.

Clause 47. The exoskeleton 100 of clause 44, wherein the passive element 560 is coupled to the first line 450 from its first end and to the first link 104 or actuator from its second end 454.

Clause 48. The exoskeleton 100 of clause 47, wherein the passive element 560 is a coil spring, and the first line 450 passes through the center of the passive element 560.

Clause 49. The exoskeleton 100 of clause 47, wherein: the actuator further comprises a first pulley 446 configured to be coupled to or move proportionally with the first element 442, and the passive element 560 is coupled to the first line 450 at its first end and to the first pulley 446 from its second end 454.

Clause 50. The exoskeleton 100 of clause 47, wherein: the first link 104 further comprises a first-link pulley 108 configured to be coupled to or move proportionally with the first link 104, and the passive element 560 is coupled to the first line 450 at its first end and to the first-link pulley 108 from its second end 454.

Clause 51. The exoskeleton 100 of clause 44, wherein: the actuator further comprises a first pulley 446 configured to rotate relative to the first element 442, and the passive element 560 is coupled to the first element 442 from its first end and to the first pulley 446 from its second end 454.

Clause 52. The exoskeleton 100 of clause 44, wherein: the first link 104 further comprises a first-link pulley 108 configured to rotate relative to the first link 104, and the passive element 560 is coupled to the first link 104 at its first end and to the first-link pulley 108 from its second end 454.

Clause 53. The exoskeleton 100 of clause 44, wherein the passive element 560 is coupled to the frame 102 from its first end and to the thigh link from its second end 454.

Clause 54. The exoskeleton 100 of clause 53, wherein the passive element 560 functions independently of the actuator 440 to create a passive supportive torque 222 in a same direction as the supportive torque 222 from the actuator.

Clause 55. The exoskeleton 100 of clause 44, wherein the passive element 560 can be quickly attached and detached from the exoskeleton 100.

Clause 56. The exoskeleton 100 of clause 44, wherein the passive element 560 creates a torque profile between the frame 102 and the first link 104 and or the second link 106 that is linear, sinusoidal, or constant.

Clause 57. The exoskeleton 100 of clause 44, wherein the exoskeleton 100 comprises a first passive element 560 configured to act between the frame 102 and the first link 104 and a second passive element 560 configured to act between the frame 102 and the second link 106.

Clause 58. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102, a second link 106 configured to be coupled to a second thigh of the person 200, wherein the second link 106 is rotatably coupled to the frame 102; and an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, a second line 456 having a second-line first end 458 coupled to the second element 444 and a second-line second end 460 coupled to the second link 106, a first pulley 446 configured to be coupled to or move proportionally with the first element 442, and a second pulley 448 configured to be coupled to or move proportionally with the second element 444, wherein: when person 200 is in a forward bent position, the actuator 440 generates a force or torque between the first element 442 and the second element 444, thereby generating a supportive torque 222 between the first link 104 and the second link 106 and the frame 102 that reduces muscle forces in the back of the person 200, and an effective diameter of the first pulley 446 or the second pulley 448 is adjustable to adjust the supportive torque 222 generated for a given value of force or torque generated from the actuator 440.

Clause 59. The exoskeleton 100 of clause 58, wherein: each of the first pulley 446 or the second pulley 448 comprises steps of varying diameter, and the first line 450 is placeable along any one of the steps of varying diameter.

Clause 60. The exoskeleton 100 of clause 58, wherein: the first pulley 446 is conical, and the first line 450 can be routed along various sections of the first pulley 446 to adjust an effective diameter of the first pulley 446.

Clause 61. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102; a second link 106 configured to be coupled to a second thigh of the person 200, wherein the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106, wherein: when the person 200 is in a forward bent position, the actuator 440 generates a force or torque between the first element 442 and the second element 444, thereby generating a supportive torque 222 between the first link 104 and the second link 106 and the frame 102 that reduces muscle forces in the back of the person 200, and an effective diameter of the first-link pulley 108 or the second-link pulley 110 is adjustable to adjust the amount of the supportive torque 222 generated for a given value of force or torque generated from the actuator 440.

Clause 62. The exoskeleton 100 of clause 61, wherein: the first-link pulley 108 or the second-link pulley 110 has steps of varying diameter, and the first line 450 is placeable along any one of the steps of varying Clause 63. An exoskeleton 100 for reducing muscle forces in legs of a person 200 during squatting, the exoskeleton 100 comprising: a frame 102 configured to be coupled to a trunk of the person 200, the frame 102 configured to move with a trunk of the person, first thigh 204, and second thigh 206; a first link 104 configured to be coupled to a first shin of the person 200, the first link 104 rotatable relative to the frame102 about an axis 608 that approximately crosses through a first knee of the person 200; a second link 106 configured to be coupled to a second shin of the person 200, the second link 106 rotatable to the frame 102 about an axis 608 that approximately crosses through a second knee of the person 200; and an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106, wherein: when the person 200 is in a squat position, the actuator 440 generates a force or torque between the first element 442 and the second element 444, thereby generating a supportive torque 222 between the frame 102 and the first link 104 and between the frame 102 and the second link 106 that reduces muscle forces in the legs of the person 200.

Clause 64. An exoskeleton 100 for reducing muscle forces in a leg of a person 200 during extension motion, the exoskeleton 100 comprising: a frame 102 configured to be coupled to a thigh of the person 200; a first link 104 configured to be coupled to a trunk of the person 200 about an axis 608 corresponding to a hip joint of the person 200; a second link 106 configured to be coupled to a shank of the person 200 about an axis corresponding to a knee of the person 200; and an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106, wherein: when the leg of the person 200 is in a bent position, the actuator 440 generates a force or torque between the first element 442 and the second element 444 thereby generating a supportive torque 222 between the first link 104 and the frame 102 to extend a hip of the person 200 and a supportive torque 222 between the second link 106 and the frame 102 to extend the person's knee joint.

Clause 65. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102, a second link 106 configured to be coupled to a second thigh of the person 200, wherein the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106; and a clutch 580 coupled between the actuator 440 and the frame 102, the clutch 580 configured to enter an engaged position and a disengaged position; wherein: when the clutch 580 is in the engaged position, the actuator 440 is prevented from rotating relative to the frame 102, and any lengthening of the first line 450 or the second line 456 to accommodate motions of the person 200 comes from the first element 442 moving relative to the second element 444, and when the clutch 580 is in the disengaged position, the actuator 440 is able to rotate relative to the frame 102, and the first link 104 is able to move in a reciprocal motion relative to the second link 106 without a change in position of the first element 442 relative to the second element 444.

Clause 66. The exoskeleton 100 of clause 65, wherein: when the person 200 is in a bent forward position, the clutch 580 enters the engaged position and the actuator 440 generates a force or torque between the first element 442 and the second element 444 thereby generating a supportive torque 222 between the frame 102 and the first link 104 and between the frame 102 and the second links 106 that reduces muscle forces in the back of the person 200, and when the person 200 is walking, the clutch 580 disengages an actuator housing from the frame 102.

Clause 67. The exoskeleton 100 of clause 65, wherein the clutch 580 is configured to utilize one or more selected from the group consisting of friction, positive engagement, fluid, electromagnetic, and overrunning actuation.

Clause 68. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102, a second link 106 configured to be coupled to a second thigh of the person 200, wherein the second link 106 is rotatably coupled to the frame 102; a first-link pulley 108 configured to be coupled to the first link 104; a second-link pulley 110 configured to be coupled to the second link 106; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first-link pulley 108, and a second line 456 having a second-line first end 458 coupled to the second element 444 and a second-line second end 460 coupled to the second-link pulley 110; a first clutch 580 coupled to the first-link pulley 108 from its first end and to the first link 104 from its second end 454, the first clutch 580 configured to enter an engaged position and a disengaged position; and a second clutch 580 coupled to the second-link pulley 110 from its first end and to the second link 106 from its second end 454, the second clutch 580 configured to enter an engaged position and a disengaged position; wherein: when the clutch 580 is in the engaged position, at least a component of rotation of the first link 104 and the second link 106 relative to the frame 102 is controlled by the actuator 440, and when the clutch 580 is in the disengaged position, the first link 104 and the second link 106 are able to rotate freely relative to the trunk frame 102

Clause 69. The exoskeleton 100 of clause 68, wherein: when the person 200 is in a bent forward position, the first clutch 580 and the second clutch 580 enters the engaged position and the actuator generates a force or torque between the first element 442 and the second element 444, thereby generating a supportive torque 222 between the first and the second links 106 and the frame 102 that reduces muscle forces in the person's back, and when the person 200 is walking, the first clutch 580 disengages the first link 104 from the first-link pulley 108, and the second clutch 580 disengages the second link 106 from the second-link pulley 110.

Clause 70. The exoskeleton 100 of clause 68, wherein the first clutch 580 and the second clutch 580 utilize one or more selected from the group consisting of friction, positive engagement, fluid, electromagnetic, and overrunning actuation.

Clause 71. An exoskeleton 100 for reducing muscle forces in a back of a person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102, a second link 106 configured to be coupled to a second thigh of the person 200, wherein the second link 106 is rotatably coupled to the frame 102; and an actuator 400 coupled to the frame 102 and comprising: a first element 442, a second element 444, wherein the first element 442 and the second element 444 are configured to rotate or translate relative to each other to create a force or torque, a first pulley 446 configured to be coupled to or move proportionally with the first element 442, a second pulley 448 configured to be coupled to or move proportionally with the first element 442, a clutch 580 configured to engage and disengage the first pulley 446 or the second pulley 448 from the first element 442, a first line 450 having a first end coupled to the first pulley 446 and a second end 454 coupled to the first link 104, and a second line 456 having a first end coupled to the second pulley 448 and a second end 454 coupled to the second link 106, wherein: when the clutch 580 is in the engaged position, the rotation of the first pulley 446 is controlled by the first element 442, and when the clutch 580 is in the disengaged position, the first pulley 446 can rotate freely relative to the first element 442.

Clause 72. The exoskeleton 100 of clause 71, wherein: when the person 200 is in a bent forward position, the clutch 580 enters the engaged position and the actuator generates a force or torque between the first element 442 and the first pulley 446, thereby generating a supportive torque 222 between the first and the second links 106 and the frame 102 that reduces muscle forces in the back of the person 200, and when the person 200 is walking, the clutch 580 disengages the first element 442 from the first pulley 446, thereby allowing the first link 104 to rotate freely.

Clause 73. The exoskeleton 100 of clause 71, wherein the clutch 580 utilizes one or more selected from the group consisting of friction, positive engagement, fluid, electromagnetic, and overrunning actuation.

Clause 74. An exoskeleton 100 for reducing muscle forces in a back of a person 200 during forward lumbar flexion, the exoskeleton 100 comprising: a frame 102 configured to be coupled to a trunk of the person 200, the frame 102 comprising: a center subframe 510 configured to sit near a center of a body of the person 200, a first subframe 512 rotatably coupled to the center subframe 510 about a differential axis and configured to sit along a right of the body, a second subframe 514 rotatably coupled to the center subframe 510 about the differential axis such that its rotation relative to the center subframe 510 is opposite to the rotation of the first subframe relative to the center subframe 510, the second subframe 514 configured to sit along the a left of the body, a first link 104 configured to be coupled to a first thigh of the person 200, wherein the first link 104 is rotatably coupled to the frame 102; a second link 106 configured to be coupled to a second thigh of the person 200, wherein the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first line 450 having a first-line first end 452 coupled to the first element 442 and a first-line second end 454 coupled to the first link 104, and a second line 456 having a second-line first end 458 coupled to the second element 444 and a second-line second end 460 coupled to the second link 106, wherein: when the person 200 bends forward, the first subframe 512 and the second subframe 514 are prevented from rotating in the same direction relative to the center subframe 510 and the actuator generates a force or torque between the first element 442 and the second element 444, thereby generating a supportive torque 222 about the axis 608 between the first and the second links 106 and the frame 102 that reduces muscle forces in the person's back, and when the person 200 walks, the first subframe 512 and the first thigh link rotate relative to the center subframe 510 about the differential axis opposite to the rotation of the second subframe 514 and the second thigh link relative to the center subframe 510 to allow the legs of the person 200 to move reciprocally.

Clause 75. The exoskeleton 100 of clause 74, wherein the differential axis is substantially colinear with the axis 608.

Clause 76. An exoskeleton 100 for reducing muscle forces in a back of the person 200 during forward lumbar flexion, the exoskeleton 100 comprising: a frame 102 configured to be coupled to a trunk of the person 200; a first link 104 configured to be coupled to a first thigh of the person 200, wherein the first link 104 is rotatably coupled to the frame 102; a second link 106 configured to be coupled to a second thigh of the person 200, wherein the second link 106 is rotatably coupled to the frame 102; an actuator 400 coupled to the frame 102 and comprising: a first element 442, a second element 444, wherein the first element 442 and the second element 444 are configured to rotate or translate relative to each other to create a force or torque, a first flexible drive shaft 595 having a first end coupled to the first element 442 and a second end 454 coupled to the first link 104, and a second flexible drive shaft 595 having a first end coupled to the second element 444 and a second end 454 coupled to the second link 106, wherein: when the person 200 is in a forward bent position, the actuator generates a force or torque between the first element 442 and the second element 444, thereby generating a supportive torque 222 between the first and the second links 106 and the frame 102 that reduces muscle forces in the back of the person.

Clause 77. The exoskeleton 100 of clause 76, wherein the flexible drive shaft 595 comprises a series of universal joints and linkages selected from the group consisting of a cardan shaft, a flexible rotary shaft, a composite shaft, and a twisted spring actuator.

Clause 78. The exoskeleton 100 for reducing muscle forces in a back of a person 200 during forward lumbar flexion, the exoskeleton 100 comprising: a first link 104 coupled to a first thigh; a second link 106 coupled to a second thigh; a control system 1100; and an actuator 440 configured to impart a supporting torque 222, wherein, when the person 200 initiates locomotion, the control system 1100 is configured to transition to a walking state and configured to transmit an instruction to the actuator 440 to apply a set level of the supporting torque 222 that allows the first link 104 to be stay coupled to the first thigh and allow the second link 106 to stay coupled to the second thigh while allow free walking

Clause 79. The exoskeleton 100 of clause 78, further comprising an input device 1160 configured to manually turn on or off a walking state.

Clause 80. The exoskeleton 100 of clause 78, wherein the supporting torque 222 is reduced as a function of time elapsed since initiation of the walking state.

Clause 81. The exoskeleton 100 of clause 78, further comprising: a first line 450, and a second line 456, wherein the control system 1100 is configured to generate instructions to the actuator 440 to produce the supporting torque 222 at a level providing an excess slack to at least one of the first line 450 or the second line 456.

Clause 82. The exoskeleton 100 of clause 78 further comprising a clutch 580, wherein the control system 1100 is configured to generate instructions to disengage the clutch 580

Clause 83. An exoskeleton 100 for reducing muscle forces in a back of a person 200 during forward lumbar flexion, the exoskeleton 100 comprising: a first link 104 coupled to a first thigh; a second link 106 coupled to a second thigh; a control system 1100; an actuator 440 configured to impart a supporting torque 222, wherein: the control system 1100 is configured to provide consistent performance during flexion and extension motion by estimating friction in the exoskeleton 100 the control system 1100 is configured to instruct the actuator 440 to automatically adapt the supporting torque 222 in the flexion and extension direction

Clause 84. The exoskeleton of clause 83, wherein: the control system 1100 is configured to receive inputs 1102 selected from the group consisting of an angle of the first link 104 and an angle of the second link 106, and the control system 1100 is configured to produce outputs 1104, based on the inputs 1102, comprising instructions to the actuator 440 to generate the supporting torque 222, further based on the friction.

Clause 85. The exoskeleton of clause 83, further comprising a set of force sensors 1172 configured to generate inputs 1102 to the control system 1100, wherein the control system 1100 is configured to produce outputs 1104, based on the inputs 1102 received from the set of force sensors 1172, comprising instructions to the actuator 440 to generate the supporting torque 222, further based on the friction.

The embodiments disclosed herein may be applied to multiple types of exoskeletons, including passive devices and devices with one, two, or more actuators. This application adds additional utility to exoskeleton devices, particularly exoskeleton devices. These and other embodiments are described further below with reference to the figures.

### BRIEF DESCRIPTION OF THE DRAWINGS

The included drawings are for illustrative purposes and serve only to provide examples of possible structures and operations for the disclosed inventive systems and methods. These drawings in no way limit any changes in form and detail that may be made by one skilled in the art without departing from the spirit and scope of the disclosed implementations.

FIG. 1 depicts a rear perspective view of the exoskeleton with a trunk interface, in accordance with some examples.

FIG. 2 depicts a simplified two-dimensional rear view of the exoskeleton, in accordance with some examples.

FIG. 3A depicts an example of the exoskeleton with a linear actuator.

FIG. 3B depicts another example of the exoskeleton with a linear actuator.

FIG. 3C depicts yet another example of an exoskeleton with a differential.

FIG. 4 depicts an example of the exoskeleton with a lockout mechanism.

FIG. 5 depicts an example of the exoskeleton series passive element between the first line and the pulley.

FIG. 6 depicts an example of the exoskeleton series passive element between the thigh pulley and thigh link.

FIG. 7 depicts an example of the exoskeleton with a passive element spring between the frame and jacket.

FIG. 8 depicts an example of an exoskeleton with a parallel passive element between the frame and thigh link.

FIGS. 9A and 9B depict an example of the exoskeleton with an adjustable jacket and line.

FIG. 10A depicts another example of the exoskeleton with an adjustable jacket in a first position.

FIG. 10B depicts an alternate example of the exoskeleton with an adjustable jacket in a second position.

FIG. 11 depicts an example of the exoskeleton with a flexible drive shaft.

FIG. 12A depicts an example of the exoskeleton with a clutch attached to a motor.

FIG. 12B depicts an example of the exoskeleton with a clutch attached to the thigh links.

FIG. 12C depicts an example of an exoskeleton with a clutch attached to pulleys.

FIG. 13A depicts an example of an exoskeleton with an integrated differential in a first configuration.

FIG. 13B depicts an example of an exoskeleton with an integrated differential in a second configuration.

FIG. 14 illustrates a schematic representation of an exoskeleton including a control system, sensors, actuators, and communication modules for managing supportive torque during user movement.

FIG. 15A-15D illustrate various examples of user input devices and adjustment parameters for modifying the supportive torque of the exoskeleton during flexion and extension motions.

FIG. 15E illustrates an exemplary graphical user interface display for adjusting operational settings of the exoskeleton, including support level, activation angle, bending speed, and walking resistance parameters.

FIG. 16 illustrates a block diagram of a computing system operable as a control system of an exoskeleton, showing key components including the processor, memory, communications unit, and storage devices configured for control and data processing, in accordance with some examples.

### DETAILED DESCRIPTION

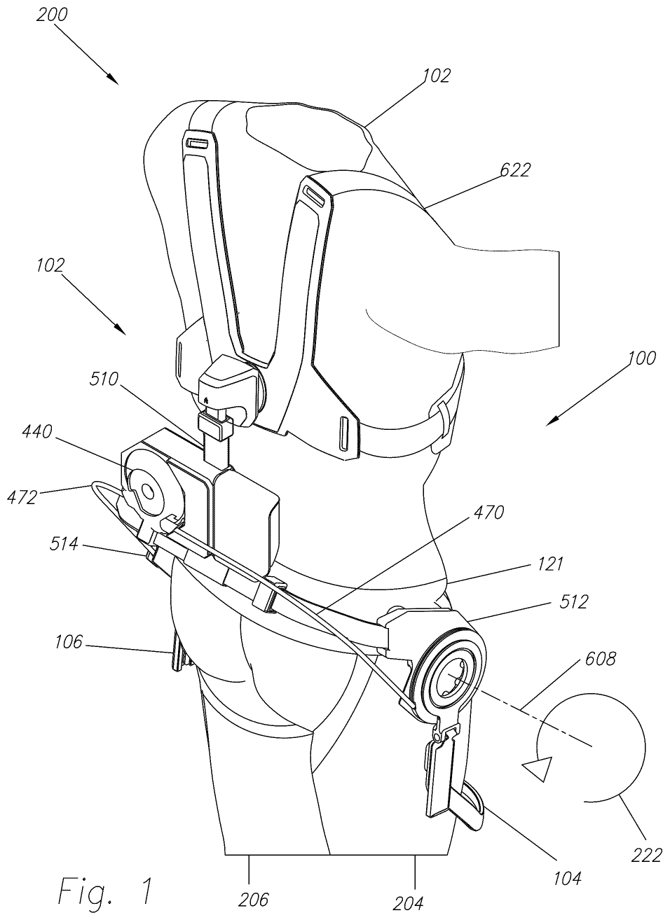

FIG. 1 shows a rear perspective view of a general embodiment of exoskeleton 100 worn by person 200. Exoskeleton 100 can include frame 102 configured to be coupled to person's trunk 202, first link 104 and second link 106 configured to be coupled to first thigh 204 and second thigh 206 of person 200, and an actuator 440 (also referred to as motor) that generates supportive torque 222 between first link 104 and frame 102 and between second link 106 and frame 102. As will be described, exoskeleton 100 can be worn by person 200 to reduce muscle forces in the person's back during forward lumbar flexion, which occurs during maneuvers such as stooping and bending. Supportive torque 222 is shown as the torque on frame 102 from actuator 440 if links 104 and 106 were grounded.

As shown in FIG. 1, exoskeleton 100 can include a first link 104 and a second link 106, which are configured to be coupled to first thigh 204 and second thigh 206 of person 200. When the first link 104 and second link 106 are coupled to the first thigh 204 and second thigh 206, first link 104 and second link 106 move in unison with the person's first thigh 204 and second thigh 206, respectively, in a manner resulting in flexion and extension of respective first and second links 104 and 106 relative to frame 102. In some embodiments, first and second links 104 and 106 are rotatably coupled to frame 102 such that the first or second links 104 and 106 can flex or extend relative to frame 102 about axis 608. In some examples, axis 608 is configured to cross approximately through the hip joint or the lower back of person 200. Following the direction of supportive torque 222 in FIG. 1, flexion of first link 104 relative to frame 102 occurs when first link 104 and frame 102 rotate towards each other. Similarly, flexion of the second link 106 relative to frame 102 occurs when the second link 106 and frame 102 rotate towards each other. Opposite to the direction of supportive torque 222 in FIG. 1, extension of first link 104 relative to frame 102 occurs when first link 104 and frame 102 rotate away from each other. Similarly, extension of the second link 106 relative to frame 102 occurs when the second link 106 and frame 102 rotate away from each other. Supportive torque 222 is configured to apply in an extension motion of the person's back between frame 102 and links 104 and 106.

Exoskeleton 100 can also include actuator 440. In some examples, actuator 440 can generate supportive torque 222 between first link 104 and frame 102 and between second link 106 and frame 102. This causes trunk interface 622 to provide a supportive force to the person's trunk and links 104 and 106 to provide a thigh reaction force to first thigh 204 and second thigh 206 of the person 200, for example, in a primary embodiment during lumbar flexion. Actuator 440 may be coupled to frame 102, first link 104, second link 106, belt 121, or trunk interface 622. Actuator 440 may also be coupled between frame 102 and first link 104 or second link 106. Actuator 440 may be powered or passive, using one or a combination of motors, pneumatics, hydraulics, elastomers, or springs. Exoskeleton 100 may apply supportive torque 222 and supportive forces in response to bending motions during activities common in working or in daily life.

One of the skills in the art may recognize that exoskeleton 100 can be configured such that supportive torque 222 can be applied to assist numerous joints and motions of person 200, other than the primary embodiment described herein, with frame 102 and links 104 and 106 attached to various other body segments of person 200. While in the primary embodiment, exoskeleton 100 is configured to support the back of person 200 during bending motions, exoskeleton 100 may also be configured to support the knee of person 200 during squatting motions, the arm of person 200 during overhead work, or other configurations common in industrial, military, medical, or recreational exoskeletons. In other embodiments, exoskeleton 100 may be configured to support two joints at the same time, such as the knee and the hip. In these examples, it may be understood by one skilled in the art to replace frame 102 and thigh link 104 with frame 102 and arm link, thigh link, and shank link, or any other combination of joints that correspond to motions of person 200. Similarly, axis 608 may be configured to cross through other joints of person 200, such as one or a combination of the knee, ankle, shoulder, elbow, neck, etc.

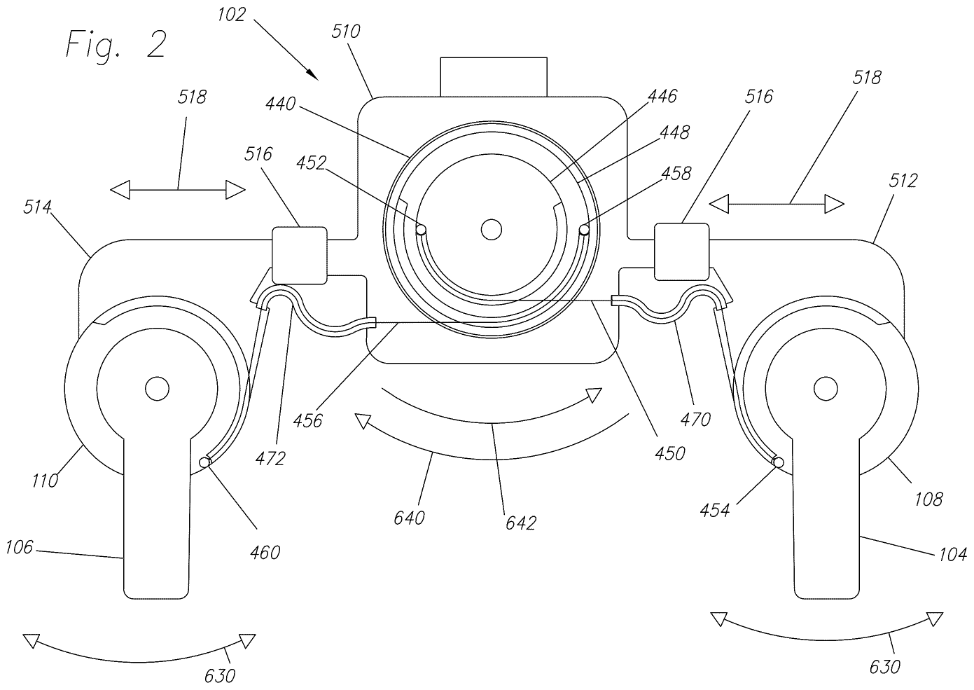

FIG. 2 shows a rear view of a portion of exoskeleton 100 as a flat pattern to better depict the relationship between components. In a primary embodiment, actuator 440 is attached to the rear side of frame 102. Actuator 440 comprises first element 442 and second element 444. In a primary embodiment, first element 442 and second element 444 are rotatable relative to each other. Additionally, actuator 440 is configured to generate an actuator torque between first element 442 and second element 444. Actuator 440 further comprises first pulley 446, which is coupled to first element 442 and turns with first element 442. Additionally, actuator 440 further comprises second pulley 448, which is coupled to second element 444 and turns with second element 444. In the embodiment of FIG. 2, only first pulley 446 and second pulley 448 are visible as they obscure first element 442 and second element 444. In some examples, the first element 442 and first pulley 446 rotate along first element rotation direction 640, and the second element and second pulley 448 444 rotate opposite it along second element rotation direction 642. Referring to FIG. 2, when the first element 442 or first pulley 446 is rotating clockwise around first element rotation direction 640, the second element 444 or second pulley 448 is rotating counterclockwise around second element rotation direction 642. First element 442 and second element 444 may refer to the housing of the actuator, the shaft of actuator 440, or two components in any transmission attached to actuator 440 that move or rotate relative to each other.

A first line 450 comprises a first-line first end 452 and a first-line second end 454. The first line 450 is wound onto a first pulley 446 from the first-line first end 452 and is also coupled to the first link 104 from the first-line second end 454. This configuration allows an actuator force or torque between the first element 442 and second element 444 to generate a tensile force in the first line 450, thereby providing an extension torque between the first link 104 and frame 102. A second line 456 comprises a second-line first end 458 and a second-line second end 460. The second line 456 is wound onto the second pulley 448 from the second-line first end 458 and coupled to the second link 106 from the second-line second end 460. The actuator torque or force between first element 442 and second element 444 generates a tensile force in second line 456, thereby providing an extension torque between second link 106 and frame 102. First line 450 or second line 456 may comprise one or a combination of wire, rope, chain, webbing, or similar flexible material. In some examples, the first line 450 and second line 456 are inextensible, but in other embodiments may have elastic or plastic properties. One skilled in the art can design a variety of mechanisms to couple first line 450 and second line 456 to first link 104 and second link 106 or to first pulley 446 and second pulley 448 to generate torque between frame 102 and links 104, 106.

In some examples, the first link 104 and second link 106 are configured to rotate relative to the frame 102 along a link rotation direction 630, corresponding to flexion and extension about axis 608. The first link 104 further comprises a first-link pulley 108 that rotates with the first link 104 along link rotation direction 630. In some examples, the first-line second end 454 is coupled to the first-link pulley 108 such that tensile forces in the first line 450 generate an extension torque between the first link 104 and frame 102. Similarly, second link 106 may further comprise a second-link pulley 110 that rotates with second link 106 along link rotation direction 630. Second end 460 of second line 456 is coupled to second-link pulley 110 such that tensile forces in second line 456 generate an extension torque between second link 106 and frame 102. Reciprocal motion is defined as when the first link 104 and second link 106 rotate in equal and opposite flexion-extension directions. Non-reciprocal motion is defined as all other motions, such as when first link 104 and second link 106 rotate in the same flexion-extension direction or when first link 104 and second link 106 rotate in unequal and opposite flexion-extension directions.

Exoskeleton 100 is configured to adjust in size to fit various sizes of person 200. As shown in FIG. 1, frame 102 is configured to couple to the trunk 202 of the person 200 and must be sized to comfortably fit the height, width, and or depth of person 200. Frame 102 may further comprise multiple components that adjust in position relative to each other to alter the size of frame 102 or exoskeleton 100. In a primary embodiment, frame 102 further comprises center subframe 510 configured to sit in a centered position on person 200, first subframe 512 adjustably coupled to center subframe 510 and configured to connect to first link 104 along the right side of person 200, and second subframe 514 adjustably coupled to center subframe 510 and configured to connect to second link 106 along the left side of person 200. Frame 102 may further comprise one or more adjustment switches 516 to allow person 200 to adjust the position of first subframe 512 or second subframe 514 relative to center subframe 510. Adjustment switch 516 is configured to selectively fix the position of first subframe 512 or second subframe 514 relative to center subframe 510. Adjustment switch 516 may have a locked state wherein first subframe 512 or second subframe 514 is fixed relative to center subframe 510 and an unlocked state wherein first subframe 512 or second subframe 514 is movable relative to center subframe 510. Adjustment switch 516 may be spring-loaded into the locked position. Adjustment switch 516 may comprise a clamp, pin, and hole or screw fasteners, buttons, slots, or other methods commonly used by those skilled in the art.

As shown in FIG. 2, the frame 102 may comprise the first adjustment switch 516 to adjust the position of the first subframe 512 relative to the center subframe 510 along frame adjustment direction 518 corresponding to the width of the person. Frame 102 further comprises a second adjustment switch 516 to adjust the position of the second subframe 512 relative to the center subframe 510 along frame adjustment direction 518 corresponding to the width of the person. In other embodiments, frame 102 may be configured to similarly adjust to the depth and or height of a person with one or multiple frame adjustment switches 516. In this manner first subframe 512 or the second subframe 514 can be configured to adjust in one or a combination of width, depth, or height relative to the center subframe 510. In any adjustment position, frame 102 is configured to transfer forces and torques between actuator 440 and person 200 to create supportive torque 222. One of the skills in the art will recognize that right and left designations of any component of the embodiments described herein may similarly be replaced with upper-lower, medial-lateral, anterior-posterior, proximal-distal, or any designations used to describe a segment or a motion of person 200 about a particular joint supported by exoskeleton 100.

To allow frame 102 to adjust in size without affecting the length of first line 450 or second line 456, exoskeleton 100 further comprises first jacket 470 and second jacket 472. First jacket 470 is configured to enclose first line 450 and connect to center subframe 510 from its first end and to first subframe 512 from its second end. Similarly, exoskeleton 100 further comprises second jacket 472 configured to enclose second line 456 to allow for size adjustment of frame 102 while maintaining torque generation with second link 106. In operation, the first jacket 470 and second jacket 472 allow for frame 102 to adjust in size without a corresponding length change in first line 450 and second line 456, respectively. First jacket 470 and second jacket 472 are made from a substantially incompressible material, such as a Bowden cable, allowing them to bend or straighten as frame 102 changes in size while transferring compressive forces that allow for the tensile forces in first line 450 to create a torque between first link 104 and frame 102 or second line 456 to create a torque between second link 106 and frame 102.

In operation, when person 200 is in the bent forward position, actuator 440 generates an actuator torque between first element 442 and second element 444. This actuator torque generates tensile forces in the first line 450 and the second line 456. These tensile forces provide extension torques between the first and second links 104 and 106 and frame 102. The extension torque resists the bending motion of the frame 102 relative to thigh links 104 and 106 to support person 200.

In operation, when person 200 is not in the forward bent position, actuator 440 halts producing actuator torque, or produces a substantially small torque, between first element 442 and second element 444, resulting in a substantially free movement of first pulley 446 and the second pulley 448 relative to each other. This consequently results in free movement of the first link 104 and second link 106 relative to frame 102, facilitating the necessary motion for locomotion, walking, climbing, and ascending stairs and slopes. Actuator 440 may allow free motion of first pulley 446 relative to second pulley 448 by being easily backdriveable. Alternatively, actuator 440 may provide slack in first line 450 or second line 456 to allow for free motion of first link 104 or second link 106. Alternatively, as described later below, clutches or differentials may also be used to allow free motion of first link 104 relative to second link 106.

### Linear Motor (or Hydraulic, Pneumatic)

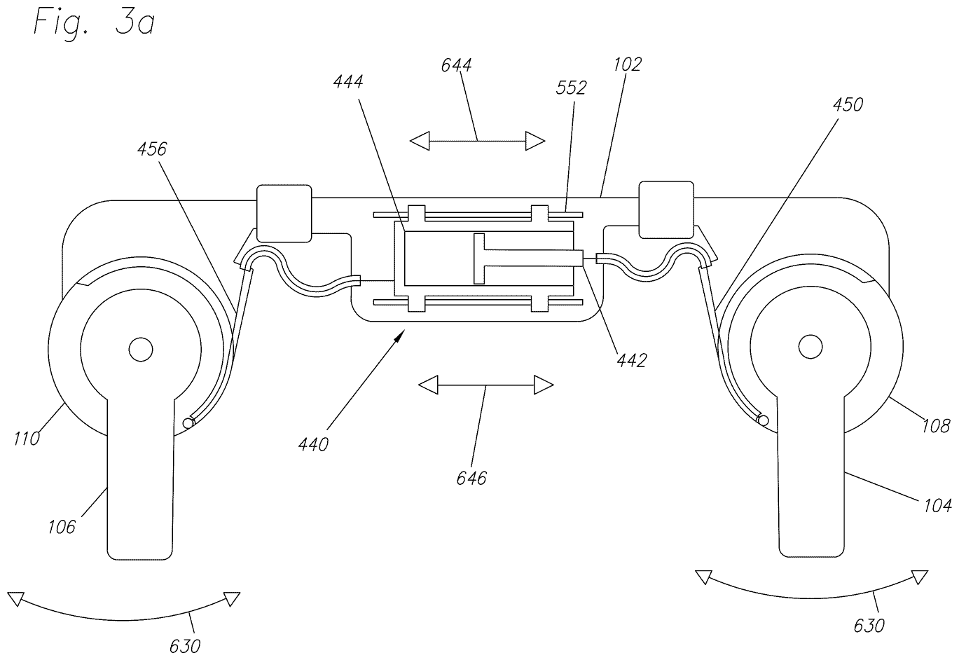

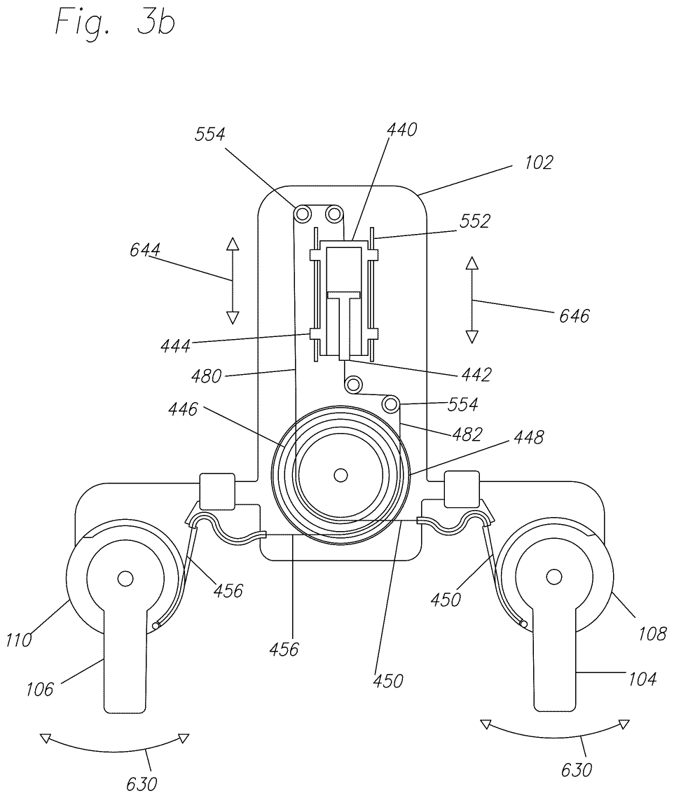

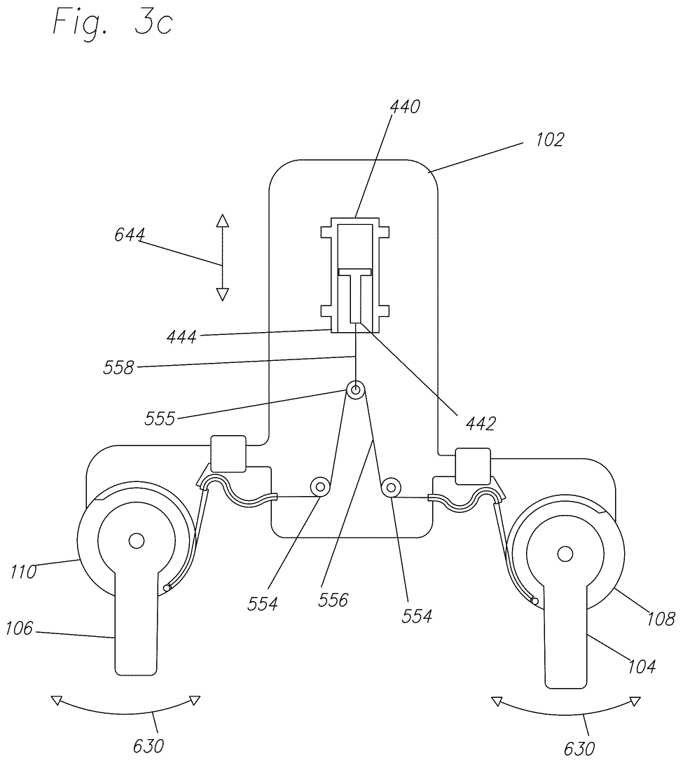

FIG. 3A, B, and C show embodiments of exoskeleton 100 using actuator 440 that operates along linear direction 644. In this example, the actuator 440 is configured to actuate the first element 442 relative to the second element 444 about the linear actuation direction 644. Actuator 440 is arranged such that first element 442 is connected to first line 450 and second element 444 is connected to second line 456 without the use of first pulley 446 or second pulley 448. Actuator 440 may utilize an electric, pneumatic, hydraulic, or other linear moving element. Actuator 440 may also utilize a rack and pinion, ball screw, or other transmission to turn a rotary motion into a linear one to create motion between first element 442 and second element 444 about linear actuation direction 644. Exoskeleton 100 may also comprise linear slider 552 configured to allow actuator 440 to move relative to frame 102 about linear degree of freedom 646. The motion of the linear degree of freedom 646 allows for reciprocal motion of the first link 104 relative to the second link 106 without relative motion of the first element 442 relative to the second element 444 from the actuator 440. This allows exoskeleton 100 to give person 200 the ability to freely walk without power being consumed by actuator 440. In some embodiments motion of actuator 440 along linear slider 552 is spring-loaded or damped. In further examples, the linear actuator 440 is arranged in parallel with a second passive element actuator, such that the actuators are arranged in parallel. Still, in some examples, the linear actuator 440 is arranged in series with a second powered or passive actuator, damper, or spring. In the embodiment of FIG. 3A, actuator 440 is arranged such that linear actuation direction 644 and linear degree of freedom 646 are substantially horizontal, but one of skill in the art may recognize that any orientation is possible with reconfiguration of components.

FIG. 3B shows an alternate embodiment of exoskeleton 100 using a linear actuator 440. In this example, the actuator 440 is arranged such that the first element 442 is connected to the first pulley 446 through the third line 480 and the second element 444 is connected to the second pulley 448 through the fourth line 482. First pulley 446 is then connected to first link 104 with first line 450, and second pulley 448 is connected to second link 106 with second line 456 as previously described. This allows for the first pulley 446 and the second pulley 448 to create a transmission ratio between the motion of the first line 450 and the third line 480 and between the second line 456 and the fourth line 482. Exoskeleton 100 further comprises at least one routing element 554 configured to route a combination of first line 450, second line 456, third line 480, and or fourth line 482 between first element 442, second element 444, first pulley 446, second pulley 448, first jacket 470, second jacket 472, first link 104, or second link 106 to minimize friction. Routing element 554 may be a pulley, drum, jacket, series of rollers, or other low-friction element. Routing element 554 may help to position components of exoskeleton 100 in a way that minimizes the size or profile of exoskeleton on person 200. In some embodiments, at least one routing element 554 is used to route first line 450 or second line 456 around frame 102 to accommodate size adjustments of frame 102 without the use of jacket 470 or 472. In the embodiment of FIG. 3B, actuator 440 is arranged such that linear actuation direction 644 and linear degree of freedom 646 are substantially vertical, but one of skill in the art may recognize that any orientation is possible with simple reconfiguration of components, as well as use with a rotary version of actuator 440.

FIG. 3C shows another embodiment of exoskeleton 100 configured such that second element 444 of actuator 440 is fixed to frame 102. Exoskeleton further comprises motor line 558 coupled to first element 442 and configured to actuate first link 104 and second link 106 simultaneously. In this example, the motor line 558 is connected to actuator 440 from its first end and to differential 555 from its second end. Differential 555 is configured to balance tensile forces applied to first link 104 and second link 106 while allowing for reciprocal motion of first link 104 and second link 106 relative to frame 102. Differential 555 may be a pulley or other mechanism. Exoskeleton 100 further comprises link line 556 coupled to first link 104 from its first end and to second link 106 from its second end, link line 556 being routed around differential 555. When actuator 440 actuates motor line 558 and thus differential 555, link line 556 simultaneously applies a tensile force to first link 104 and second link 106. At all times, the example of FIG. 3C allows for the reciprocal motion of first link 104 relative to second link 106 through motion of link line 556 about differential 555. At least one routing element 554 may similarly be used to route the first motor line 558 or link line 556 around frame 102 to minimize friction. One of the skills in the art may recognize that a similar configuration may be utilized where actuator 440 creates rotational motion instead of linear motion. The mechanisms of the described embodiments that apply to first line 450 and second line 456 may similarly apply to motor line 558 and link line 556.

### Support Topic

The primary function of exoskeleton 100 is to provide supportive torque 222 to the user. In the primary embodiment where exoskeleton 100 is a trunk supporting exoskeleton as shown in FIG. 1, this primary function is to provide an extension torque or support about the lower back or hip joint of person 200. Actuator 440 provides torque 222 by creating tension to first line 450 and second line 456, which in turn apply a force to first link 104 and second link 106, which rotate relative to frame 102 about axis 608. The amount of torque relative to the angle of flexion between frame 102 and thigh links 104, 106 can be governed by the control strategy adjusting the force output of actuator 440, by diameter or profile of pulleys connected to either end of the lines or across the hip joint, or also by springs, clamps, or dampers put in parallel or series to actuator 440 and line system.

### Cable Static Lockout

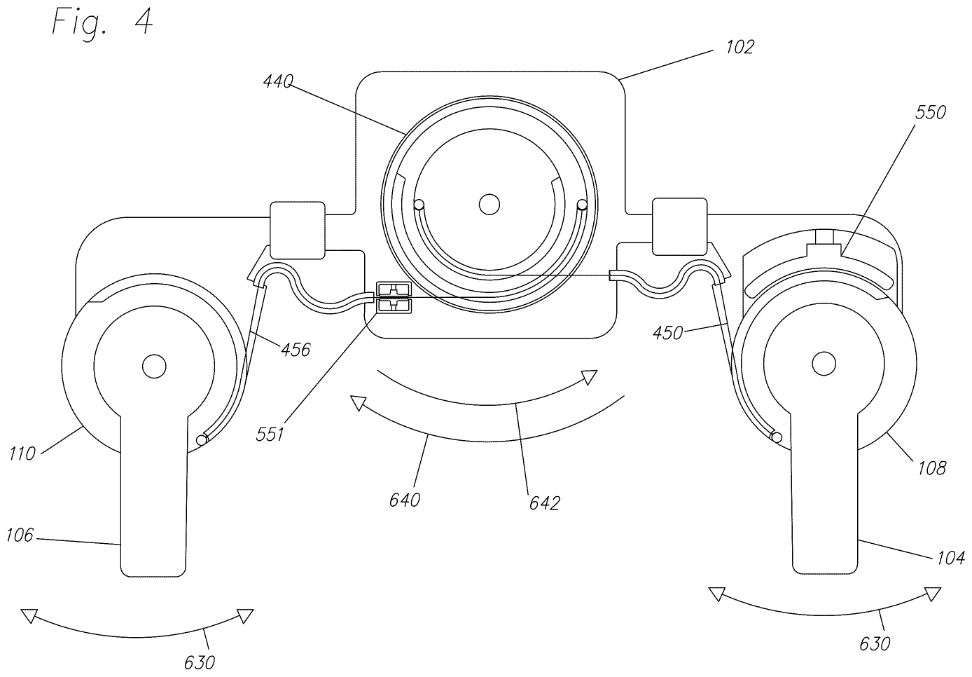

FIG. 4 shows an embodiment where exoskeleton 100 further comprises lockout mechanism 550. When using exoskeleton 100, some users may remain in a bent posture for prolonged periods of time, requiring actuator 440 to create a continuous supportive torque 222. This may quickly drain a battery or cause heat buildup/wear in actuator 440. Lockout mechanism 550 is configured to provide resistance to or prevent the motion of first link 104 or second link 106 relative to frame 102 in a manner that bypasses actuator 440. Lockout mechanism 550 may be manually activated or electronically activated based on sensors in exoskeleton 100, such as with a solenoid. Lockout mechanism 550 may be configured to completely lock the motion of first link 104 or second link 106 relative to frame 102 in at least one direction, or provide a slight amount of spring-loaded or damped motion before motion is completely prevented. Lockout mechanism 550 may comprise a brake that can be progressively loaded to supplement actuator 440 while person 200 is static or moving. FIG. 4 shows two different embodiments of the lockout mechanism 550 on the right and left halves of the exoskeleton 100.

Lockout mechanism 550 may be configured to selectively couple first element 442 to second element 444 or first pulley 446 to second pulley 448. When the lockout mechanism 550 is in an unlocked position, the lockout mechanism 550 does not influence the motion of the first link 104 or the second link 106 relative to the frame 102, and when the lockout mechanism 550 is in a locked position, the first link 104 and the second link 106 are prevented from flexing relative to the frame 102.

As shown on the right side of exoskeleton 100 in FIG. 4, lockout mechanism 550 may be configured to fix the position of first link 104 relative to frame 102. In this example, the forces from the lockout mechanism 550 are not transferred through the first line 450 in addition to the actuator 440, reducing stress on the line system. In this configuration, lockout mechanism 550 may be a clamp, brake, meshing gear, ratchet, one-way bearing, pin and hole, or other mechanism used to limit the rotation of two links. When the lockout mechanism 550 is in a locked position, the first link 104 is prevented from moving in at least a flexion motion relative to the frame 102. In some embodiments, lockout mechanism 550 is configured to prevent first link 104 from moving in a flexion motion relative to frame 102 but provide free extension motion. In other embodiments, lockout mechanism 550 is configured to prevent first link 104 from moving in a flexion or extension motion relative to the frame 102. One of the skills in the art may recognize that, in this example, the lockout mechanism 550 may be placed first subframe 512 or second subframe 514 of the exoskeleton 100 and may be configured to lock out the first link 104 or second link 106. Similarly, lockout mechanism 550 may be used to selectively fix frame 102 to first pulley 446 or second pulley 448. Exoskeleton 100 may comprise a lockout mechanism 550 configured to act on first link 104 and an additional lockout mechanism 551 to act on second link 106.

In some embodiments, lockout mechanism 550 is configured to enter a locked position when person 200 has remained in a bent posture for longer than a specified duration of time. Lockout mechanism 550 may be triggered electronically by a solenoid based on data received from sensors on exoskeleton 100.

As shown on the left side of exoskeleton 100 in FIG. 4, additional lockout mechanism 551 may be configured to fix the motion of second line 456 relative to frame 102. In this embodiment, additional lockout mechanism 551 may be a tooth, pin, clamp, brake, one-way bearing, cleat, lockable pulley, or other mechanism. When the additional lockout mechanism 551 is in a locked position, second link 106 is prevented from moving in a flexion motion relative to frame 102, and all reaction forces travel from second link 106 through second line 456 to lockout mechanism 550 and then to frame 102. When the additional lockout mechanism 551 is unlocked, the exoskeleton 100 functions as previously described. One of the skills in the art may recognize that, in this embodiment additional lockout mechanism 551 may be placed on the center subframe 510, first subframe 512, or the second subframe 514 of the exoskeleton 100 and may be configured to lock out the first line 450 or second line 456. Exoskeleton 100 may comprise a lockout mechanism 550 configured to act on first line 450 and an additional lockout mechanism 551 to act on second line 456.

### Cable Series Springs/Dampers

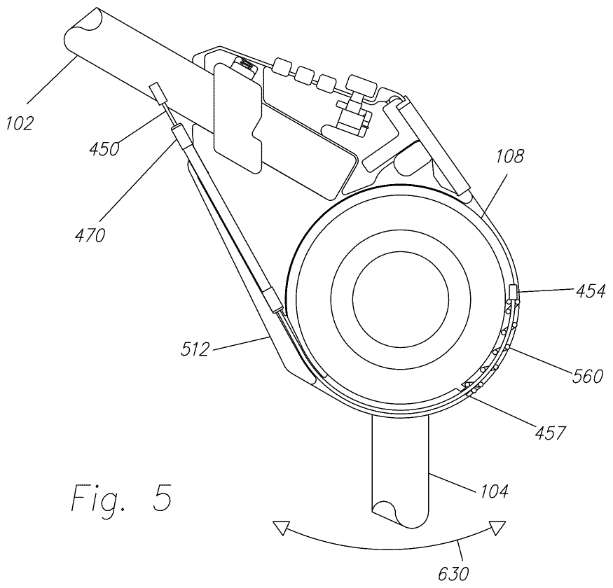

Exoskeleton 100 may be configured with passive element 560 arranged in series or parallel with the force transmission chain of first element 442, first pulley 446, first line 450, first-link pulley 108, first link 104, or similarly that of second element 444, second pulley 446, second line 456, second-link pulley 110, second link 106. Alternatively, passive element 560 may be placed between jacket 470 and frame 102. Passive element 560 may augment supportive torque 222 provided by actuator 440, such as to provide a quicker response to person 200, add compliance to the system, alter or reduce motor torque output requirements, improve force control or impact absorption, to dissipate, store, or release energy, or to act as a mechanical force filter. Passive element 560 may act as a spring, damper, or a combination thereof. Passive element 560 may function independently of actuator 440 and may contain springs, dampers, on/off selective engagement, force adjustment, set engagement position, engagement position adjustment, or other features described in the prior art of passive exoskeleton technology. FIGS. 5, 6, and 7 show various embodiments of series passive element 560 on a detailed view of the connection of first subframe 512 to first link 104. One of the skills in the art may recognize that these are for illustrative purposes, and similar configurations are possible between the second subframe 514 and second link 106, and between the center subframe 510 and first element 442 or second element 444.

FIG. 5 shows an embodiment of exoskeleton 100 where passive element 560 is configured to act between first line 450 and first-link pulley 108. In the embodiment of FIG. 5, a first end of passive element 560 is coupled to first-link pulley 108, and the second end of passive element 560 is coupled to the end of first line 450. In some examples, the first line 450 or the second line 456 may have stoppers at either end to facilitate connection with components such as first pulley 446, second pulley 448, first-link pulley 108, second-link pulley 110, or passive element 560. In the embodiment shown, passive element 560 comprises a coil spring configured to sit in the groove of first-link pulley 108. One end of passive element 560 rests on hard stop 457 of first link pulley 108. First line 450 passes through the center of passive element 560 and comprises a crimped connector on the first-line second end 454. The crimped connector rests on the second end of passive element 560. When actuator 440 creates torque 222 through tension on first line 450, passive element 560 is compressed between first line 450 and first link pulley 108. In other embodiments not shown, passive element 560 is located between first pulley 446 and first line 450. In another embodiment, passive element 560 is located between second line 456 and second link pulley 110 or second pulley 448. In some embodiments, exoskeleton 100 comprises first passive element 560 in series with first line 450, and second passive element 560 in series with second line. In other embodiments, exoskeleton 100 comprises first passive element 560 in series with first-line first end 452 and second passive element 560 in series with the first-line second end 454. One or a combination of the first pulley 446, second pulley 448, first thigh pulley 108, or the second thigh pulley 110 may comprise a hard stop 457. Hard stop 457 may be configured to transfer forces from passive element 560 or to limit rotation in at least one direction.

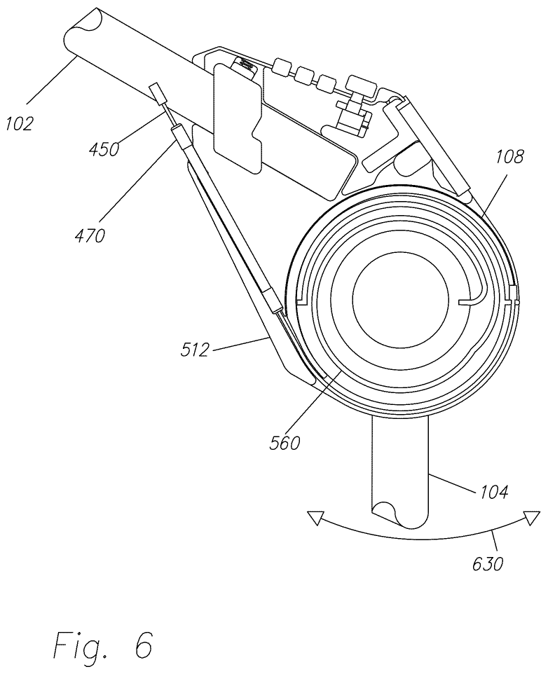

FIG. 6 shows an embodiment of exoskeleton 100 where passive element 560 is placed between first-link pulley 108 and first link 104. In this embodiment, first-link pulley 108 is configured to rotate relative to first link 104 in a spring-loaded fashion. In the embodiment of FIG. 6, passive element 560 comprises a clock spring, with its first end coupled to first-link pulley 108 and its second end coupled to first link 104. When actuator 440 creates torque 222, tension forces on first line 450 rotate first-link pulley 108 relative to first link 104, compressing passive element 560. Exoskeleton may further comprise a second passive element 560 coupled between second-link pulley 110 and second link 106, where second-link pulley 110 is configured to rotate relative to second link 106. In this embodiment, passive element 560 may similarly comprise a spring, damper, or combination thereof. This configuration of passive element 560 may similarly be used to create forces between first element 442 and first pulley 446 or second element 444 and second pulley 448.

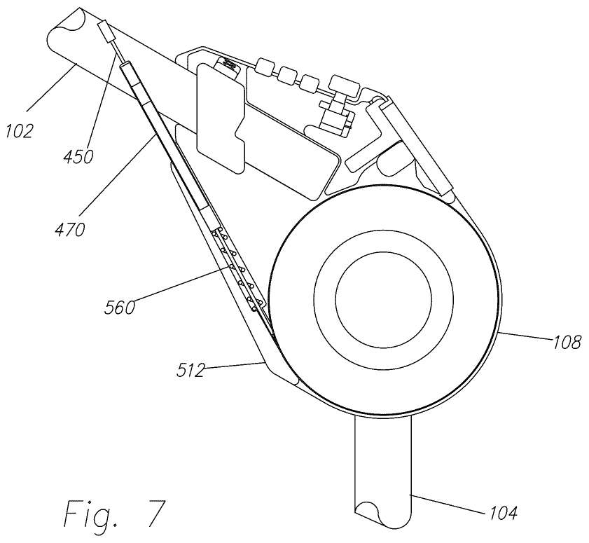

FIG. 7 shows an embodiment of exoskeleton 100 where passive element 560 is placed between jacket 470 and first subframe 512. In this embodiment, jacket 470 is configured to translate within a channel of frame 102. A first end of passive element 560 is coupled to frame 102, and a second end of passive element 560 is coupled to jacket 470. Passive element 560 may be more specifically coupled between center subframe 510 and jacket 470 or between first subframe 512 and jacket 470, as shown. In the embodiment of FIG. 7, passive element 560 is a coil spring, and first line 450 passes through the center of passive element 560. When actuator 440 creates torque 222 by applying tension to first line 450, jacket 470 experiences compressive forces to counter tensile forces in first line 450. In the embodiment of FIG. 7, passive element 560 is compressed by these compressive forces between jacket 470 and frame 102, thus applying a series of springs or a damping force to the tension in first line 450. This configuration of passive element 560 may be used between frame 102, center subframe 510, first subframe 512, second subframe 514, first jacket 470, and second jacket 472.

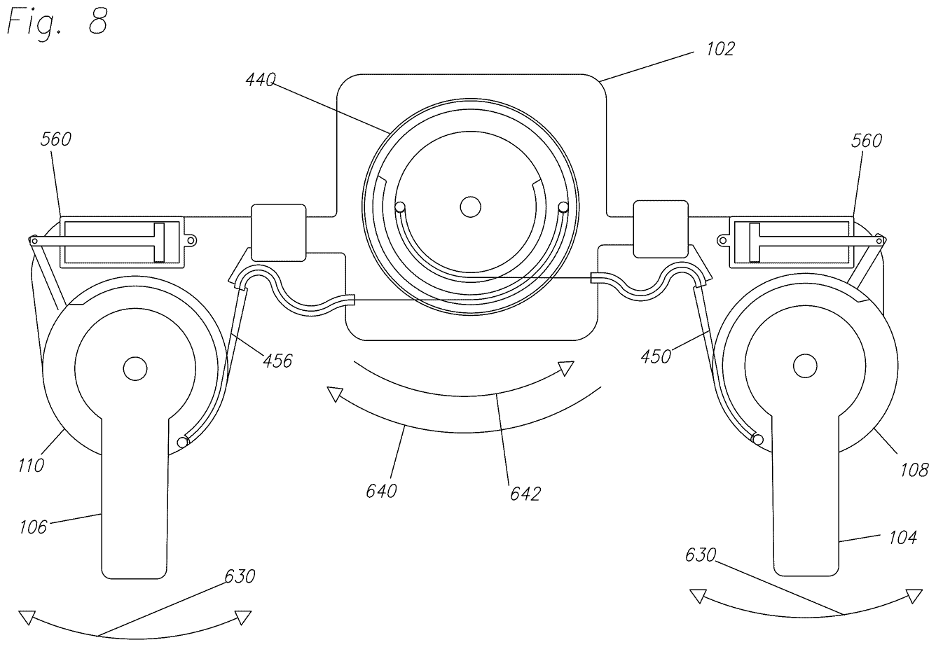

As shown in FIG. 8, passive element 560 may also be placed in parallel to any part of the force transmission chain of first element 442, first pulley 446, first line 450, first-link pulley 108, first link 104, or similarly that of second element 444, second pulley 446, second line 456, second-link pulley 110, and second link 106. In this embodiment, passive element 560 is coupled to first subframe 512 of frame 102 from its first end, and to first link 104 or first-link pulley 108 on its second end, wherein first-link pulley 108 is fixed to first link 104. In this embodiment, passive element 560 may function independently of actuator 440 and create a passive supportive torque in the same direction as supportive torque 222 from actuator 440. Passive element 560 may contain springs, dampers, on/off selective engagement, force adjustment, set engagement angle, engagement angle adjustment, or other features described in the prior art of passive exoskeleton technology. Passive element 560 may be quickly removable from exoskeleton 100 for a modular parallel active-passive combination. The torque profile of passive element 560 may be configured to adjust with the changing angle between thigh link 104 and frame 102. The torque profile of passive element 560 may be linear, sinusoidal, constant, or a combination thereof. In the embodiment of FIG. 8 exoskeleton comprises a first passive element 560 configured to apply a force between frame 102 and first link 104, and a second passive element 560 configured to apply a force between frame 102 and second link 106.

Passive element 560 may function such that when the person 200 is in a forward bent position and the lockout mechanism 550 is in an unlocked position, the actuator 440 and the passive element 560 generate a force or torque between the first element 442 and the second element 444, thereby generating a supportive torque 222 between the first and the second links 106 and the frame 102 that reduces muscle forces in the back of the person 200, and when the person 200 is in a forward bent position and the lockout mechanism 550 is in an locked position, only the passive element 560 generates a force or torque between the first element 442 and the second element 444, thereby generating a supportive torque 222 between the first and the second links 106 and the frame 102 that reduces muscle forces in the back of the person 200. This allows for some compliance to be built into the exoskeleton 100 when the lockout mechanism 550 is active, which may improve the comfort or range of motion of the person 200 during static bending postures.

### Frame Adjustment Topic

In a primary embodiment, exoskeleton 100 adjusts in size to allow for the device to fit a differently-sized person 200. Such adjustments may include trunk height, trunk depth, trunk width, thigh length, arm length, hip circumference, or any other common measure of the human body. A difficulty arises when the first line 450 or the second line 456 that transfers tensile forces between frame 102 and links 104, 106 acts between a portion of exoskeleton 100 that adjusts in dimension. Because actuator 440 transfers forces by shortening/lengthening the effective length of first line 450 or second line 456, adjustment in frame size may alter the support properties of the device or affect the limits of travel of actuator 440, lines, links, or pulleys. Thus, it is desirable for a mechanism to allow for the compensation of motor-line-pulley system length in relation to the adjusted size of the exoskeleton frame 102 or thigh link 104. In the primary embodiment, this is accomplished using a jacket 470 of sufficient length for the largest size of exoskeleton 100. Jacket 470, as understood by one skilled in the art, uses an incompressible material such that an inner first line 450 or second line 456 can transfer tensile forces between its two endpoints. Jacket 470 may bend or change in shape while allowing first line 450 or second line 456 to maintain tension. A primary detriment of this approach is the extra profile and combined bend radii of jacket 470 when exoskeleton 100 is in its smallest size setting. The longer the jacket 470 becomes, the larger the friction forces between the first line 450 and jacket 470. Additionally, more combined bending occurs throughout its length, and the radii of the bends all cause additional friction between jacket 470 and first line 450. This friction adds to the resistance of the exoskeleton 100 when person 200 is flexing, and subtracts from the exoskeleton support torque 222 when person 200 is extending. Thus, it is ideal for friction to be minimized by limiting the length, number of bends, and tightness of bending in jacket 470 and second jacket 472. In one embodiment not shown, a combination of jacket 470, second jacket 472, first line 450, and second line 456 is quickly replaceable to match the size setting of frame 102.

### Linear DOF in Cables and End Mechanism

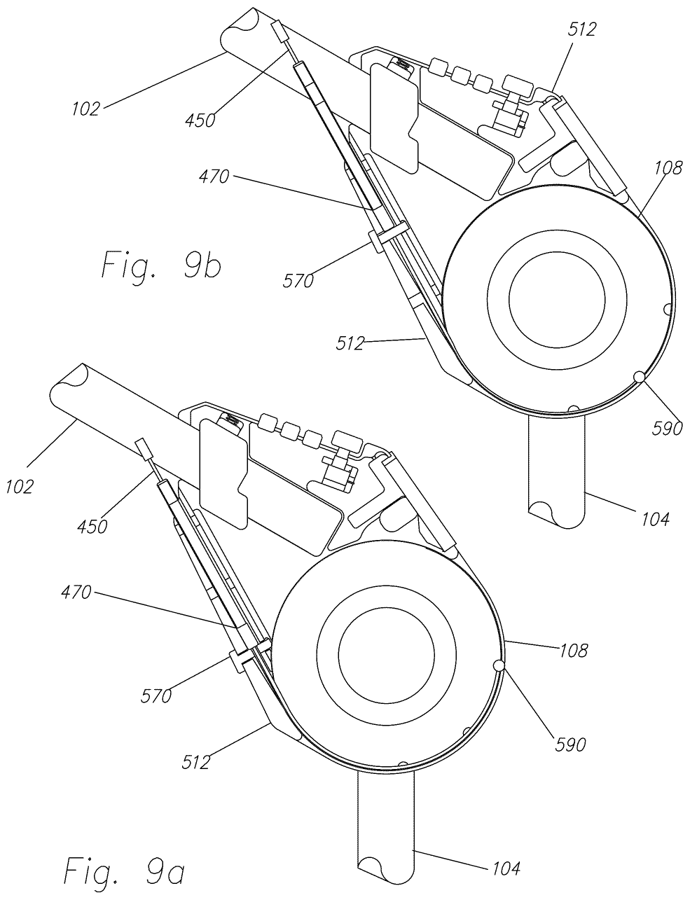

FIGS. 9A and 9B show an embodiment of exoskeleton 100 wherein jacket 470 is adjustable relative to frame 102. Jacket 470 is configured to slide linearly relative to frame 102 at either the connection to center subframe 510, first subframe 512, or second subframe 514. Exoskeleton further comprises a jacket adjustment mechanism 570 configured to fix the position of the end of jacket 470 relative to frame 102. Jacket adjustment mechanism 570 is configured to enter a locked or unlocked position. When the jacket adjustment mechanism 570 is in an unlocked position, the end of the jacket 470 can move relative to the frame 102. This allows for the effective length of jacket 470 to adjust in conjunction with an adjustment to the size of frame 102. When the jacket adjustment mechanism 570 is in a locked position, the end of jacket 470 is fixed relative to the frame 102, allowing jacket 470 to transfer compressive forces between its connection points on first subframe 512 or second subframe 514 and center subframe 510. This adjustment of the position of jacket 470 relative to frame 102 minimizes the length and total bend radius of jacket 470 while allowing for torque transfer of the motor-cable-pulley. In some embodiments, jacket 470 is configured to slide linearly relative to center subframe 510, first subframe 512, or second subframe 514, and exoskeleton comprises first jacket adjustment mechanism 570 between jacket 470 and center subframe 510 and second lock between jacket 470 and first subframe 512 or second subframe 514. Jacket adjustment mechanism 570 may comprise a pin and hole coupling as shown in FIGS. 9A and 9B.

In FIG. 9A jacket 470 is set to a shorter setting relative to first subframe 512, corresponding to a smaller size setting of frame 102. In FIG. 9B jacket 470 is set to a longer setting relative to first subframe 514, corresponding to a larger size setting of frame 102. Jacket adjustment mechanism 570 may also consist of a clamp, ratchet, spring-loaded button, or other mechanism recognized by one skilled in the art to adjust and fix a location between two components in a discrete or continuous manner.

In some embodiments of exoskeleton 100, also depicted in FIG. 9A and B, the effective length of first line 450 or second line 456 is adjustable. This may be used in conjunction with the adjustment in the position of jacket 470 to optimize exoskeleton 100 for various-sized users. Adjustment in the length of the first line 450 or the second line 456 may also adjust the relative angle of thigh links 104, 106 relative to frame 102 at a neutral position of actuator 440 or to adjust the range of travel of thigh link 104 influenced by first line 450. In the embodiment of FIGS. 9A and 9B exoskeleton further comprises a line adjustment mechanism 590 configured to adjust the position at which the first line 450 attaches to the first-link pulley 108. Line adjustment mechanism 590 is configured to enter a locked or unlocked position or also referred to as an engaged or disengaged position. In an unlocked position of the line adjustment mechanism 590, the end of the first line 450 can move along the groove of the first-link pulley 108. In a locked position of the line adjustment mechanism 590, the end of the first line 450 is fixed along the first-link pulley 108. Line adjustment mechanism 590 may comprise a continuously adjustable clamp or a series of fixed positions between first line 450 and first pulley, as shown. In FIG. 9A first line 450 is set to a shorter setting relative to first-link pulley 108, corresponding to a smaller size setting of frame 102 or a first position of first link 104 relative to trunk frame 102. In FIG. 9B first line 450 is set to a longer setting relative to first-link pulley 108, corresponding to a larger size setting of frame 102 or a second position of first link 104 relative to trunk frame 102. Line adjustment mechanism 590 may also consist of a clamp, ratchet, spring-loaded button, or other mechanism recognized by one skilled in the art to adjust and fix a location between two components in a discrete or continuous manner. In another embodiment not shown, the end of the first line 450 comprises a pawl, and ratchet teeth are embedded into the first-link pulley 108. In this embodiment line adjustment mechanism 590 automatically allows for a lengthening of the first line 450 relative to the first-link pulley 108, corresponding to the thigh link 104, to moving in a flexion direction relative to frame 102. Line adjustment mechanism 590 automatically prevents first line 450 from moving or shortening relative to first pulley 108 when tensile forces are applied to first line 450 or thigh link 104 extends relative to frame 102. This allows for transfer or tensile forces to create a supportive torque 222. One of the skills in the art may recognize a line adjustment mechanism 590 may similarly be configured between first line 450 and first pulley 446 and/or first-link pulley 108, and between second line 456 and second pulley 448 and/or second-link pulley 110. In some embodiments, exoskeleton 100 comprises first line adjustment mechanism 590 on first line 450 and second line adjustment mechanism 590 on second line 456.

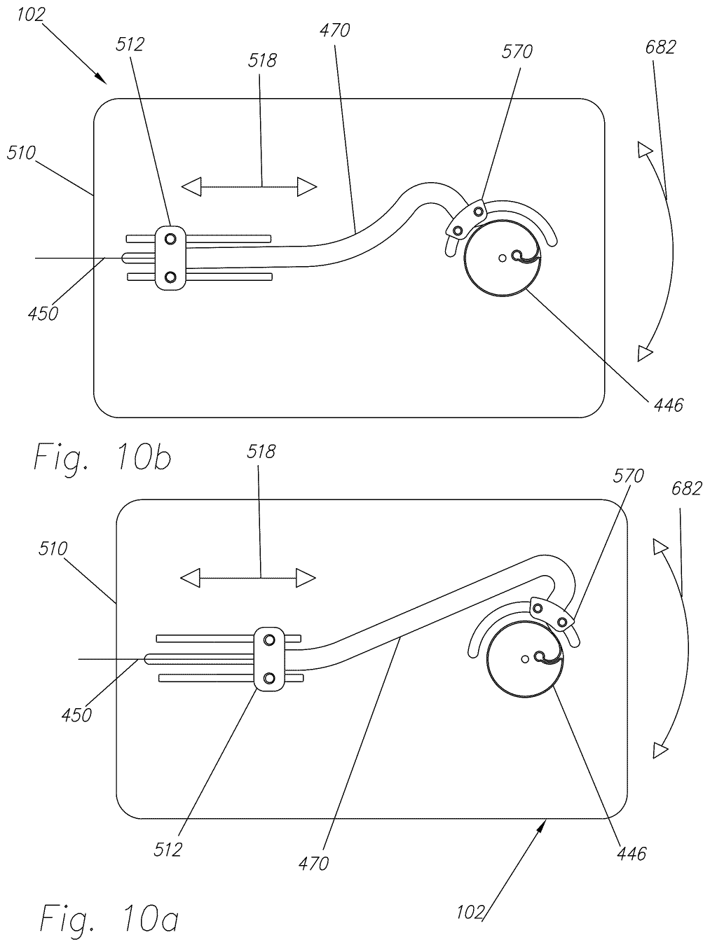

FIGS. 10A and 10B shows an alternate embodiment of exoskeleton 100 wherein jacket adjustment mechanism 570 is configured to rotate or translate along a circular path relative to frame 102 corresponding to the rotation axis of first pulley 446 or second pulley 448. FIGS. 10A and 10B shows a simplified mechanical configuration of exoskeleton 100 and frame 102 wherein center subframe 510 is depicted as a base plate, and first subframe 512 adjusts relative to center subframe 510 along frame adjustment direction 518. Jacket adjustment mechanism 570 is moveably coupled to center subframe 510 along circular path 682. Jacket 470 is of fixed length and couples to first subframe 512 from its first end and to jacket adjustment mechanism 570 from its second end. FIG. 10A shows a configuration when frame 102 is in a small setting and the first subframe 512 is moved towards the first pulley 446. FIG. 10B shows a configuration where frame 102 is in a large setting and the first subframe 512 is moved away from the first pulley 446. During the adjustment of frame 102, jacket adjustment mechanism 570 moves or rotates to a position that minimizes the bend radius or cumulative bend of jacket 470. Cumulative bend is defined as the addition of the bend angles of all individual bends in jacket 470 in any direction. Jacket adjustment mechanism 570 also allows for a shorter section of jacket 470 to be used on exoskeleton 100 than would otherwise be possible. In some embodiments jacket adjustment mechanism 570 continuously adjusts and is selectively locked in place by a brake or a clamp. In other embodiments jacket adjustment mechanism 570 discreetly adjusts and is locked in place by screws, quick-release pins, buttons, ratchets, etc. Still in other embodiments, jacket adjustment mechanism 570 is configured to attach to jacket 470 in an orientation tangent to first pulley 446 such that the position of jacket adjustment mechanism 570 is not affected by tensile forces in first line 450 or corresponding compressive forces in jacket 470. In this configuration position of the jacket adjustment mechanism 570 may be influenced by internal forces in jacket 470 due to the size of frame 102, such that it automatically adjusts to the desired position where internal forces in jacket 470 are minimized, such as forces due to the bending of jacket 470. Jacket adjustment mechanism 570 may similarly be configured on trunk frame 102 to act about first-link pulley 108, and or second-link pulley 110.

### Pulleys (Adjustable, Multiple Wraps, Cam)

In some embodiments, not shown, one or a combination of first pulley 446, second pulley 448, first-link pulley 108, or second-link pulley 110 of exoskeleton 100 is configured to take up more than one full revolution of first line 450 or second line 456. This may allow for compensation of adjustments previously described, for a greater range of motion of exoskeleton 100, or for a greater transmission ratio between pulleys. For example, first pulley 446 may comprise a spiral-shaped groove to accommodate multiple wraps of first line 450, or first line 450 may be configured to overlap itself on a second revolution. In other embodiments, the diameter of first pulley 446 may be adjustable or may be shaped in a cam profile. In other embodiments, first pulley 446 may comprise a series of stepped pulleys of different diameters, wherein first line 450 can be placed onto varying steps of first pulley 446 to alter the effective diameter. In other embodiments, first pulley 446 is conical and can be adjusted such that first line 450 wraps around varying sections of first pulley 446 to alter the effective diameter of first pulley 446. The effective diameter comprises the functional diameter of the first pulley 446 about which the first line 450 wraps.

### Flexible Drive Shaft

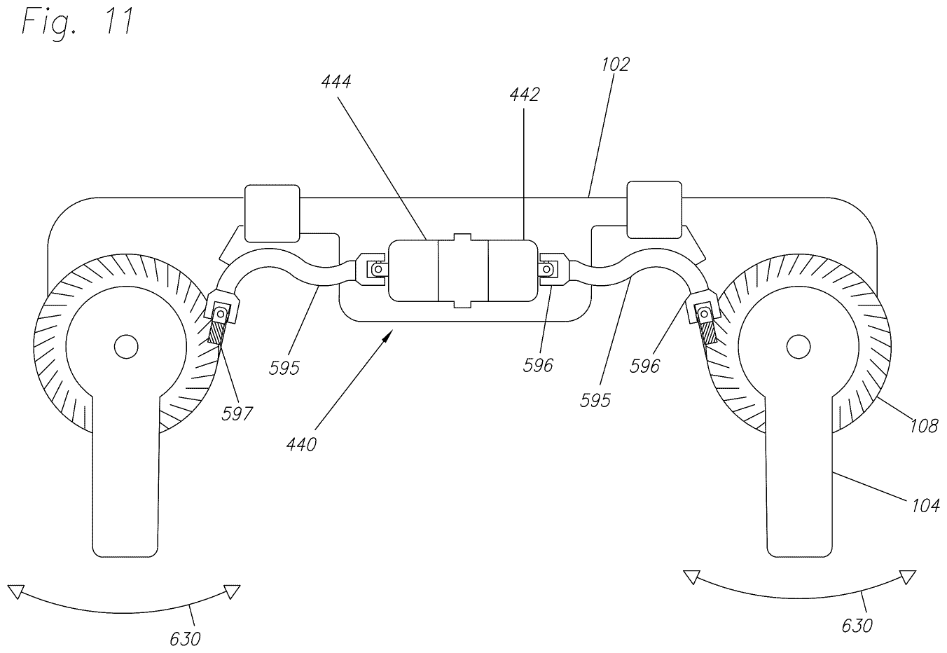

In another embodiment, as shown in FIG. 11, exoskeleton 100 may have at least one flexible drive shaft 595 in place of first line 450, second line 456, motor line 558, and their respective jacket 470. Flexible drive shaft 595 is configured to transfer torque from actuator 440 to the rotation of first link 104 and second link 106 about frame 102. Actuator 440 may comprise an electric motor or two or more electric motors. Actuator 440 may comprise gearing, or with gearing to adapt the transmission of force, speed, or torque, with at least two outputs connected to each respective flexible drive shaft 595. The outputs may be offset offset 180 degrees. The opposite ends of the flexible drive shaft 595 end in a joint between frame 102 and thigh link 104 about axis 608, driven by the flexible drive shaft 595. The respective joint has no gearing or has gearing to adapt the transmission ratio of the force, speed, and torque. Actuator 440 can also be rotatably mounted to enable at least two outputs by rotating the actuator 440. Each end of the flexible drive shaft 595 may comprise a universal joint 596 or gearing 597 to transmit torques between the flexible drive shaft 595 and the actuator 440, first link 104, or second link 106.

In some examples, the actuator 440 is located on the back of the exoskeleton, connected to a support. The joints are arranged in the region of the hip axis of the exoskeleton 100 and transmit the force/torque to the first link 104 and second link 106 in order to support hip flexion and/or extension. In further examples, the joints and actuator 440 are positioned in a stable position relative to one another, e.g., via a support. In some examples, the position between actuator 440 and the joints can be adapted, for example, by lengthening or shortening the support, and any other construction can also be used. For this purpose, flexible drive shaft 595 can have a length compensation with force drivers, for example, can be telescopic. Flexible drive shaft 595 is provided sufficiently long so that it can be adapted to the different lengths by bending, and additional length compensation with force drivers can also be provided. Examples of mechanisms of flexible drive shaft 595 may include a series of universal joints and linkages, such as cardan shafts, flexible rotary shafts comprised of wire, composite shafts, or twisted spring actuators.

### Frame as Cable Jacket

In other embodiments not shown, the function of jacket 470 is embedded into frame 102. Frame 102 may comprise a series of routing elements 554 configured to hold tension on first line 450 or second line 456 as frame 102 adjusts in size. The routing element may comprise rollers, pulleys, or other elements that reduce friction or define a bend radius of the first line 450 or second line 456.

### Walking Topic

The following embodiments relate to actuator 440 creating the supporting forces and torques that are applied to person 200. Importantly, actuator 440 must be configured to apply supporting forces to the person during postures such as bending, but also configured to allow the person's legs to move freely or independently during other motions such as walking. While the walking motion involves relatively reciprocal motion between person's first thigh 204 and the second thigh 206, it is often not perfectly reciprocal. The following embodiments detail how reciprocal and semi-reciprocal motion may be achieved between the right thigh link 104 and left thigh link 106 by means of altering the actuation system, transmission system, or frame of exoskeleton 100.

In some examples, when person 200 is not in the forward bent position, actuator 440 generates a substantially small torque between first element 442 and second element 444. The small actuator torque allows thigh links 104 and 106 to stay connected with first thigh 204 and second thigh 206, but move with a small resistance relative to frame 102 during walking, climbing, and ascending stairs and slopes. This requires management of actuator 440 by a control system and draining of the battery. Actuator 440 may also provide slack to first line 450 or second line 456 to provide for free movement of first link 104 or second link 106 relative to trunk frame 102 for reciprocal or non-reciprocal motions. This, however, requires management of the slack and introduces a delay when actuator 440 next applies supportive torque 222. Actuator 440 may also be backdriveable between first element 442 and second element 444 to provide for reciprocal or non-reciprocal motions of first link 104 and second link 106 relative to trunk frame 102.

### Clutch Disengagement

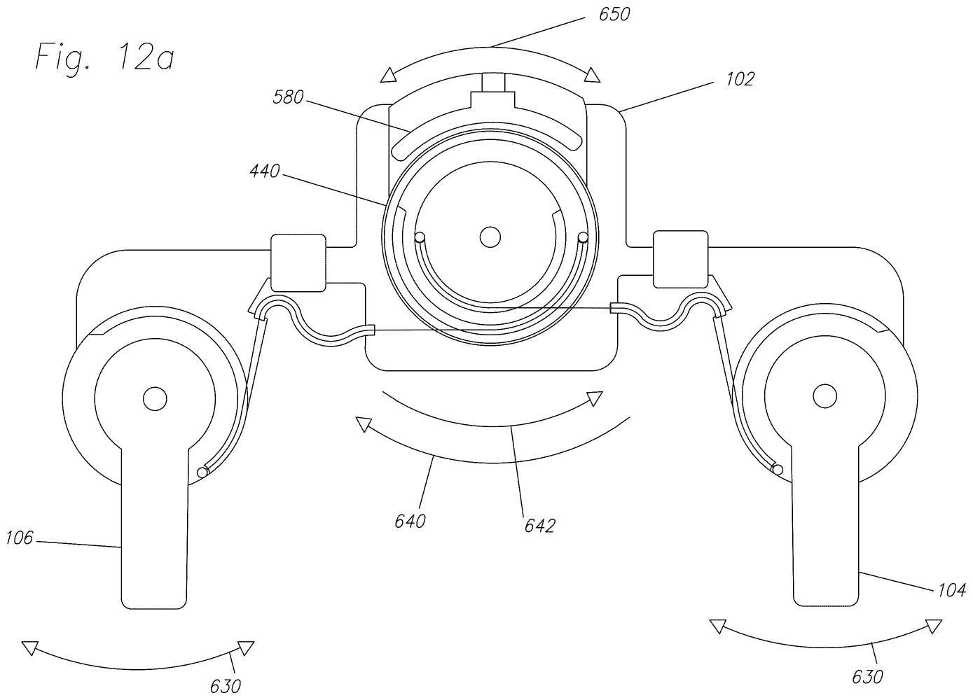

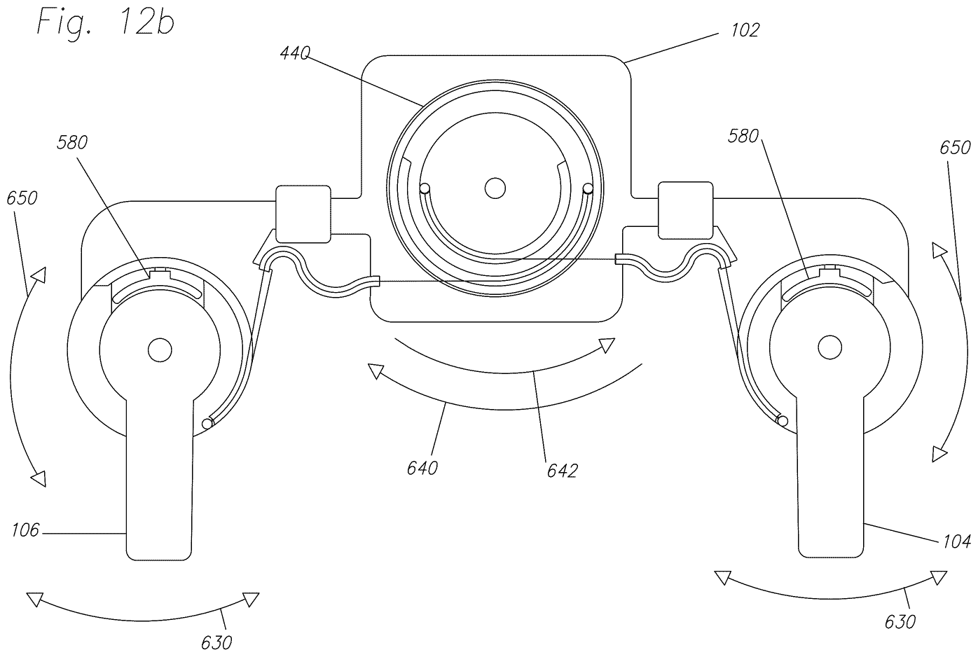

FIGS. 12A, 12B, and 12C show an embodiment where exoskeleton 100 further comprises clutch 580. Clutch 580 is configured to selectively disengage the supportive torque 222 applied to first link 104 and or second link 104 from actuator 440. When engaged, clutch 580 allows for exoskeleton 100 to transfer supportive torque 222 to person 200 such that exoskeleton 100 operates as described previously. When disengaged, clutch 580 allows for thigh links 104 and or 106 to rotate more freely relative to frame 102 about axis 608. By disengaging clutch 580, person 200 may be more able to freely walk, run, sit, or perform other secondary job tasks or daily activities that do not require supportive torque 222. Clutch 580 may be engaged and disengaged mechanically or electronically. Engagement of clutch 580 may be triggered by a control system of exoskeleton 100. Clutch 580 may be spring-loaded into an engaged or a disengaged position. Clutch 580 may utilize friction, positive engagement, fluid, electromagnetic, or overrunning actuation.

FIG. 12A shows an embodiment of exoskeleton 100 where clutch 580 is configured between frame 102 and actuator 440. When clutch 580 is engaged, the body of actuator 440 is fixed to frame 102. Any lengthening of the first line 450 or second line 456 to accommodate motions of person 200 must then come from the actuation of actuator 440 or passive back driving first element 442 and second element 444 of actuator 440. When clutch 580 is disengaged, actuator 440 may rotate relative to frame about clutch rotation direction 650. This allows actuator 440 to work as a passive differential between first link 104 and second link 106 as described in the prior art for motions such as walking or running. When the first line 450 shortens during walking, the second line 456 lengthens proportionally due to the rotation of actuator 440 about frame 102, causing first pulley 446 to wind first line 450 while second pulley 448 proportionally unwinds second line 456. Simultaneously lengthening the first line 450 and the second line 456 for motions such as sitting will require active motion or passive back driving of actuator 440. Any non-reciprocal motion of first link 104 and second link 106 must still come from actuator 440, providing slack, back driving, maintaining small torque, or one of the other described strategies. One of the skills in the art may recognize that clutch 580 may also be configured in a linear direction for embodiments of exoskeleton 100 with a linear actuator 440. The addition of clutch 580 allows for a greater number of transmission options between actuator 440, first pulley 446, and second pulley 448.

Clutch 580 configured to enter an engaged position and a disengaged position; wherein when the clutch 580 is in an engaged position, the actuator 440 is coupled to the frame 102 such that when the lockout mechanism 550 is in the locked position neither the first link 104 or the second link 106 can rotate relative to the frame 102 in a flexion direction, and when the clutch 580 is in a disengaged position, the actuator 440 is rotatable relative to the frame 102, such that when the lockout mechanism 550 is in the locked position, the first link 104 is able to move in a reciprocal motion relative to the second link 106 without a change in position of the first element 442 relative to the second element 444.

FIG. 12B shows an embodiment of exoskeleton 100 where clutch 580 is configured between first link 104 and first-link pulley 108, and between second link 106 and second-link pulley 110. When clutch 580 is engaged, first link 104 is fixed to first-link pulley 108. This allows actuator 440 to transfer tensile forces between frame 102 and first link 104 to create torque 222 about axis 608 as previously described. When clutch 580 is disengaged, first link 104 can rotate independently of first-link pulley 108 about axis 608 relative to frame 102. This allows for person 200 to move freely for secondary motions as well as engage in reciprocal or non-reciprocal motion of first thigh 204 and second thigh 206 relative to trunk 202. First-link pulley 108 may hard stop against trunk frame 102 such that actuator 440 can maintain tension of first line 450 or for a predictable position of first-link pulley 108. Exoskeleton 100 may comprise a first clutch 580 between frame 102 and first link 104, and a second clutch 580 between frame 102 and second link 106. A similar embodiment, not shown, may be used to engage and disengage first pulley 446 from first element 442 and second pulley 448 from second element 444 of actuator 440.

FIG. 12C shows an embodiment of exoskeleton 100 where actuator 440 comprises first element 442 configured to proportionally drive both first pulley 446 and second pulley 448. In this embodiment, second element 444 consists of the housing of actuator 440 and is fixed to frame 102. Exoskeleton 100 further comprises clutch 580 configured to engage or disengage first pulley 446 from first element 442. When clutch 580 is engaged, first element 442 can transfer forces and torques to first pulley 446. When the clutch is disengaged, first pulley 446 can rotate freely. FIG. 12C shows a linear embodiment of clutch 580 acting between first element 442 and first pulley 446, and a rotational linkage embodiment of clutch 580 acting between actuator 440 and second pulley 448. One of the skills in the art is to recognize the various types of clutch that are possible, and the figures serve an illustrative purpose. Exoskeleton may comprise a first clutch 580 affecting the first link 104 and a second clutch 580 actuating the second link 106, which can be actuated together or independently. Alternatively, clutch 580 may be configured to engage and disengage first pulley 446 and second pulley 448 at the same time. A number of routing elements 554 may be used to effectively route the first line 450 or second line 456 around frame 102. One of the skills in the art may recognize that a similar mechanism may be used in the axis 608 motion of exoskeleton 100.

### Frame with Integrated Differential

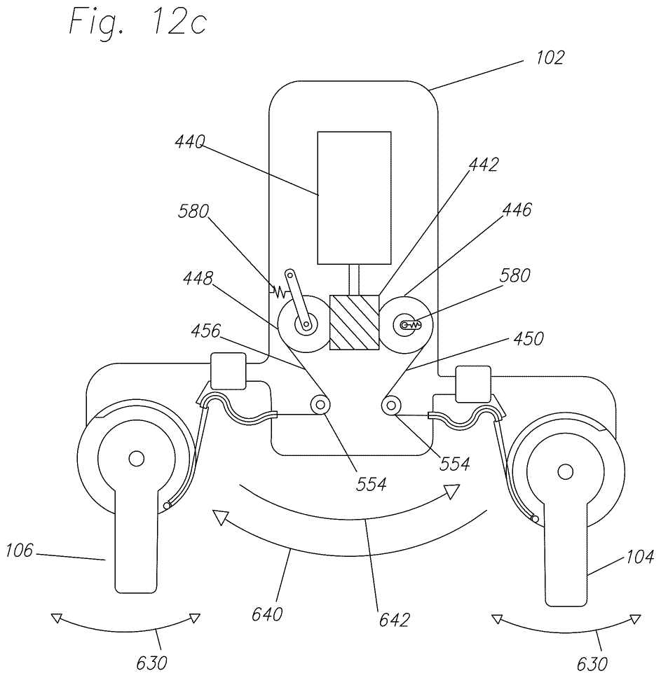

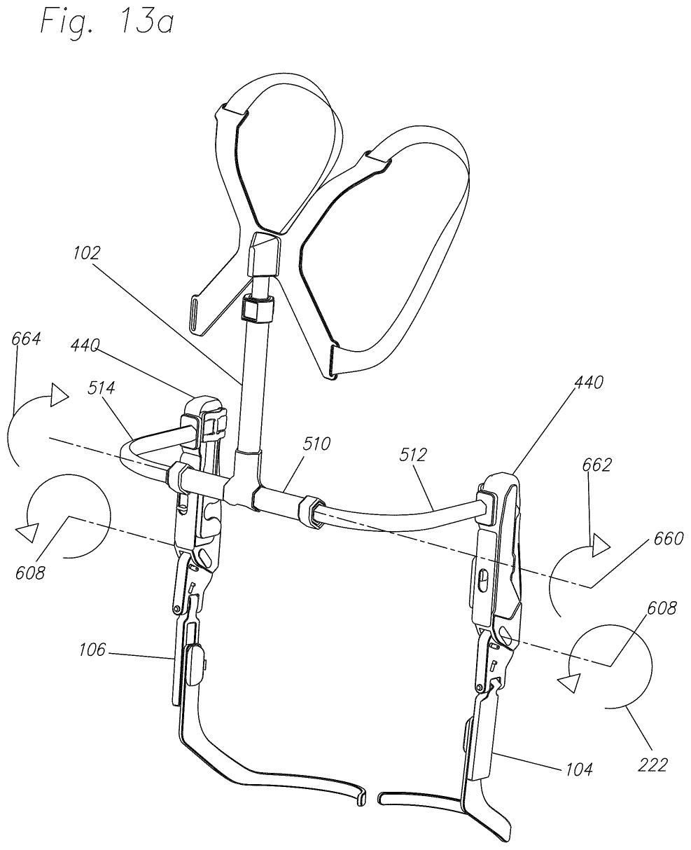

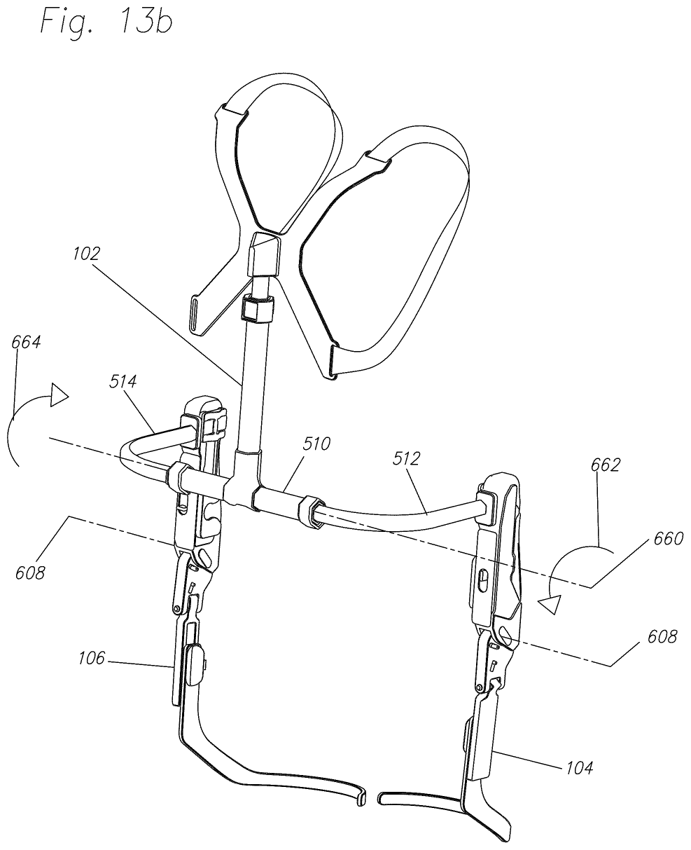

FIGS. 13A and 13B show an embodiment where a walking differential is built into frame 102. In this embodiment, outputs from actuator 440 are directly connected to first link 104 and second link 106 or any configuration previously described. First line 450 or second line 456 can be in a push or pull direction, or any of the force transmission methods known by one of skill in the art may be used. In the embodiment of FIGS. 13A and 13B, frame 102 comprises center subframe 510, first subframe 512 configured to rotate relative to center subframe 510 about differential rotation axis 660, and second subframe 514 also configured to rotate relative to center subframe 510 about differential rotation axis 660. Frame 102 is configured such that the second subframe 514 can only rotate in the opposite direction relative to the center subframe 510 compared to the direction of rotation of the first subframe 512 relative to the center subframe 510. When the first subframe 512 rotates about the rotation axis 660 in the first subframe rotation direction 662, the second subframe 514 can only rotate in the second subframe rotation direction 664 opposite to the first subframe.

FIG. 13A shows an embodiment of exoskeleton 100 when person 200 is bending and supportive torque 222 is applied about axis 608. In this embodiment, reaction forces and torques from person 200 and actuator 440 act to rotate first subframe 512 and second subframe 514 in the same direction relative to center subframe 510. When the first subframe rotation direction 662 and the second subframe rotation direction 664 are the same about the differential axis 660, the frame prevents both the first subframe 512 and the second subframe 514 from rotation relative to the center subframe 510. This allows for frame 102 to transfer the reaction forces and torques required to generate and apply supportive torque 222 to person 200. In this embodiment, exoskeleton 100 rotates about axis 608 between frame 102 and thigh links, and no rotation occurs about differential axis 660.

FIG. 13B shows an embodiment of exoskeleton 100 with integrated differential when person 200 is walking. In this embodiment, the reaction forces and torques from person 200 act to rotate first subframe 512 and second subframe 514 in an opposite direction relative to center subframe 510. In this configuration first subframe 512 and the second subframe 514 can each rotate relative to the center subframe 510 so long as their rotation directions are opposite. In this configuration, exoskeleton 100 rotates about differential axis 660, and some or no rotation may occur about axis 608. In some embodiments, frame 102 is designed such that differential axis 660 crosses approximately through the hip joint of person 200. In some embodiments, frame 102 is designed such that differential axis 660 is approximately coincident with axis 608. Approximately corresponds to as closely as the exoskeleton can be fit by a reasonably trained person, or the level of alignment between joints or axes such that the exoskeleton 100 does not uncomfortably rub or chafe person 200 due to joint misalignment.

### Motor as a Fan

In some embodiments, when actuator 440, first pulley 446, second pulley 448, first-link pulley 108, second-link pulley 110, routing element 554, or other rotating or translating element of exoskeleton 100 comprises fins, blades, or other elements configured to move air. For the sake of brevity, actuator 440 will be used as an example. When actuator 440 rotates relative to frame 102, air is blown onto person 200 for a cooling effect.

### Push-Pull Cable

In some embodiments, first line 450 and second line 456 are push-pull cables, and actuator 440 is configured to apply supportive torque 222 and a torque opposite to supportive torque 222. Walking or other motions may be provided through clutch 580 as previously described.

### Exoskeleton Control Systems

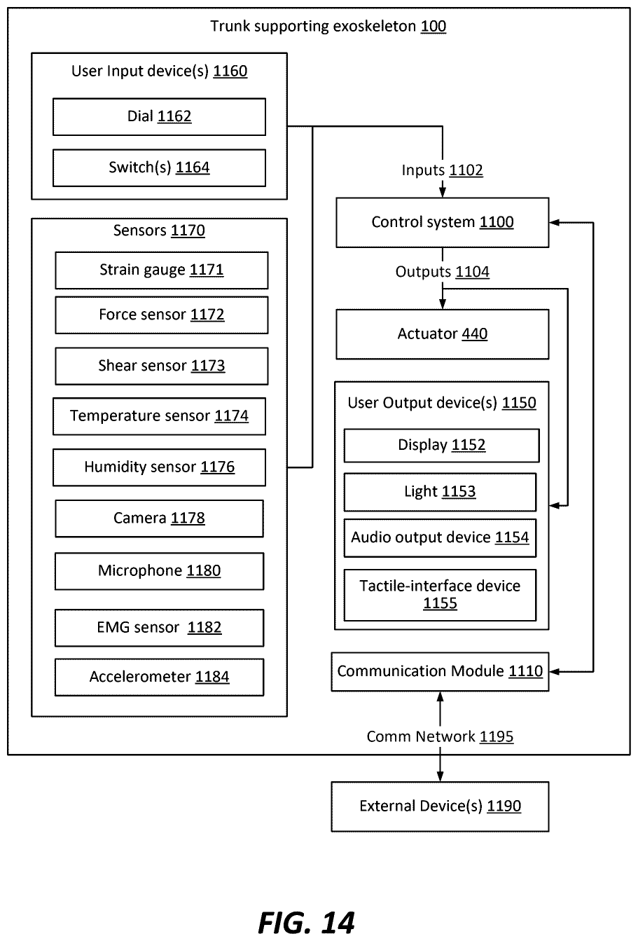

Referring to FIG. 14, in some examples, exoskeleton 100 comprises control system 1100, configured to receive a variety of inputs 1102 and to generate corresponding outputs 1104. For example, an exoskeleton 100 may be equipped with one or more user-input devices 1160, one or more sensors 1170, and/or one or more user-output devices 1150, all of which may be communicatively coupled to the control system 1100. The exoskeleton 100 may also be equipped with a communication module 1110, coupled to the control system 1100 and configured to communicate with one or more external devices 1190 (e.g., a user's cellphone, computer, central control servers, etc.). This communication may be performed over various communication networks 1195, in particular, wireless networks, such as cellular networks, Wi-Fi, and the like. Overall, control system 1100 increases the effectiveness of supportive torque 222 in reducing the muscle forces of the person 200 during bending tasks and allows the person 200 to move freely during secondary tasks without interference from supporting torque 222 of the exoskeleton 100.

Various inputs 1102 (to the control system 1100) are within the scope, e.g., (1) an angle, velocity, and/or acceleration of the person's trunk, (2) a relative angle, velocity, and/or acceleration of the frame 102 relative to the first link 104 and/or second link 106, (3) a relative angle, velocity, and/or acceleration between the first link 104 and second link 106, (4) a battery state (e.g., state of charge, voltage, temperature), (5) the tension in first line 450 and/or second line 456, (6) an actual value of supporting torque 222, (7) one or more measured forces between the interface of exoskeleton 100 and person 200, (8) usage duration of the exoskeleton 100, (9) the measured friction in the first link 450 and/or second line 456, and (10) the state of the lockout mechanism 550 and/or the clutch 580. These inputs may be collected during an initialization process and/or throughout the use of exoskeleton 100. Due to adjusting and fitting the exoskeleton on a user, variations may exist between the angle of the person's trunk and the frame 102. In some examples, during initialization, the absolute angle of frame 102 is measured when the person is in an upright configuration to assess the frame orientation relative to the person's trunk. This allows calculations of the supporting torque that would offset the forces due to gravity on the person's trunk while only requiring information from frame 102. In some examples, a user may provide an input to initialize the frame 102 at an angle of their choosing (trunk is in a bent forward position or trunk is in a bent back position) using manual inputs into the system. This may be performed to allow earlier support by the exoskeleton in the case where the trunk is bent back, and later support if initialization occurs in the bent forward position.

For instance, in some examples, the desired supporting torque profile is sinusoidal, as a function of the exoskeleton frame angle, with the maximum supporting torque occurring at a 90-degree bent position of the frame relative to the initialization location. Initializing with the person's trunk in the upright position allows the person's trunk to experience maximum supporting torque at a substantially 90-degree bent position. If the initialization location is set when the person is bent forward, the maximum supporting torque occurs at angles higher than 90 degrees. If the initialization location is set when the person is bent rearwardly, the maximum supporting torque occurs at angles lower than 90 degrees. Additionally, the person's trunk may experience a larger support torque in the upright position, which can be beneficial for low-angle trunk bent work, such as table work. Similarly, during operation, the input of the angle of the person can be used to change the supporting torque.

These inputs 1102 may be user-provided inputs, sensor-provided inputs, and/or externally-provided inputs (e.g., inputs received from other devices communicatively coupled to the exoskeleton 100). In general, the control system 1100 may capture various data of the state of exoskeleton 100, the motion of person 200, and/or the environment while the exoskeleton 100 is worn and in use (collectively referred to as inputs 1102). The control system 1100 is configured to transition the exoskeleton 100 into different states based on the inputs 1102.

Outputs of the control system 1100 may include (1) the timing and/or magnitude of supportive torque 222 to be generated by the actuator 440, e.g., for a given position, velocity, and/or the acceleration of person 200, (2) sound, light, haptics, and/or data as described below.

### User Adaptation

In some examples, the control system 1100 may adapt a preset state to inputs 1102, e.g., current and/or historical inputs associated with a specific person 200 and/or task performed by this person 200 (while wearing the exoskeleton 100). For example, control system 1100 may receive and/or aggregate various user-specific inputs 1102, e.g., (a) training data for mistriggers, (b) inputs from one or more electromyography (sEMG) sensors that are configured to detect user's muscle signals, (c) user's previous motion data, (d) camera feed of the user's environment and anticipation of next action (e.g., a kind of box is being lifted), (e) input characteristics of anthropometry person 200, and/or (f) input characteristics of the satisfaction of person 200 with exoskeleton.

### Walking State

In some examples, the exoskeleton 100 transitions into a walking state when the person 200 initiates locomotion. The walking state is configured to minimize the interference of exoskeleton 100 or, more specifically, of the supporting torque 222 with the walking motion of the person 200. The walking state can be detected by the control system 1100 from various inputs 1102 that identify reciprocating motion between the first link 104 and second link 106, such as the angle, velocity, and/or acceleration of the first link 104 and frame 102 compared to that of the second link 106 and frame 102. For example, the reciprocating motion is identified by checking that the direction of the velocity of the first link 104 relative to frame 102 and the direction of the velocity of the second link 106 relative to frame 102 are different. In other examples, in addition to the different directions of motion of the first link 104 and second link 106, the magnitude of velocity of the first link 104 and second link 106 must exceed a predefined value to initiate the walking state. This reduces the effect of noise in the system and small motions associated with milling about or postural adjustments. In some examples, the person 200 uses input device 1160 to manually turn on or off automatic transition to the walking state. When the automatic transition to walking state is allowed and person 200 initiates a bend after locomotion, the support torque 222 may be delayed. Person 200 may choose to turn the automatic transition to walking state off to ensure support torque 222 is immediately initiated on bending.

Specifically, when the walking state is detected, the control system 1100 generates one or more corresponding outputs 1104, e.g., (1) transmitted as an instruction to the actuator 440 not to impart the supporting torque 222 between the person's trunk 202 and each of the first thigh 204 and second thigh 206, (2) transmitted as an instruction to the actuator 440 not to apply substantially small supporting torque 222 (e.g., a substantially small supporting torque may provide minimal to no resistance to the user's first and second thighs when walking, but just enough torque to allow the first link 104 and second link 106 to be coupled on the first and second thighs respectively), (3) transmitted as an instruction to the actuator 440 to give an excess slack to the first line 450 and/or second line 456, and/or (4) transmitted as an instruction to the clutch 580 to disengage the clutch 580. This allows the person 200 walk freely as they do not have to fight the supporting torque 222 at the thighs.

In some examples, the control system 1100 periodically repeats the walking state determination. For example, when the reciprocation is detected, the supporting torque 222 is reduced, while the percentage of the torque reduction may be a time input function of the control system 1100, e.g., how long after the initial reciprocation is detected the reciprocation activity continues. For example, if the first thigh and the second thigh are reciprocating (moving in opposite directions) and the speed of the thighs is above a predefined threshold, a walking state is triggered, and the time of initiation is registered. The supporting torque 222 is then reduced as a function of time elapsed since the initial trigger of the walking state, and if the control system continues to be in the walking state. The torque may decrease substantially as the time increases. The time and state act as a reference for the increasing probability of walking. In some examples, the function might be a linear, exponential, or quadratic decrease in supporting torque 222.

In some examples, when the person 200 assumes a stooped posture, the exoskeleton 100 is configured to apply supportive torque 222 between the frame 102 and each of the first link 104 and second link 106, i.e., to assist in maintaining the posture. Upon the initiation of locomotion by person 200 (detected by the control system 1100), the actuator 440 (from the instructions provided by the control system 1100) ceases to apply the supporting torque 222. In some examples, the supporting torque 222 is reduced to substantially zero during locomotion.

In some examples, in the walking state control system 1100 command clutch 580 to move into a disengaged position. When not in the walking state, control system 1100 commands clutch 580 into an engaged position.

### Static Lockout

In some examples, when person 200 assumes a stooped posture with returns to full extension for a prolonged period, the control system 1100 may transmit a command to the lockout mechanism 550 to the locked state. The prolonged period may be a fixed time, a function of the thermal properties of actuator 440 and its ability to dissipate heat, or a function of the discharge rate of the battery. In some examples, the inputs 1102 of the temperature of the motor and or the rate of discharge of the battery are used to transmit a command to the lockout mechanism 550 to enter a locked state.

In the locked state, lockout mechanism is configured to selectively couple the frame 102 to one or a combination of the first line 450, the second line 456, the first link 104, the second link 106, the first pulley 446, the second pulley 448, the first-link pulley 108, and the second-link pulley 110 such that the first link 104 or the second link 106 is prevented from moving relative to the frame 102 in at least one direction. The control system 1100 can further command the lockout mechanism 550 to an unlocked state where the lockout mechanism 550 does not influence the motion of the first link 104 or the second link 106 relative to the frame 102.

### Asymmetrical Bending

In some embodiments, exoskeleton 100 may enter an asymmetrical bending state when control system 1100 detects that the person 200 is bending asymmetrically. Inputs 1102 to the control system 1100 may include the angle of the first link 104 and the second link 106 relative to frame 102 or the person's trunk. During Asymmetrical bending, the relative angle of the first link 104 with respect to the absolute trunk angle or frame 102 and the relative angle of the second link 105 relative to the frame 102 or absolute trunk angle differ, and the velocities of the first link 104 and the second link 105 may also differ. In the asymmetrical bending state, the control system 1100 may reduce supportive torque 222, increase supportive torque 222, and/or indicate to the person 200 that an asymmetrical bend occurred via a light, sound, haptic vibration, and/or pulse of the supportive torque 222.

### Continuous Friction Monitoring and Compensation

In some examples, the control system 1100 adapts to friction forces between various hardware units of the exoskeleton 100. For instance, the friction (in the exoskeleton 100) acts in the same direction as the supporting torque 222 by resisting the motion of person 200 during flexion. As the exoskeleton 100 also resists motion to provide support during flexion, the friction adds to the effort of the exoskeleton 100. When the person 200 is extending, while the exoskeleton is providing an assistive supporting torque 222 in the direction of motion, the friction acts opposite to the supporting torque 222 by resisting the motion of person 200. Thus, to obtain a consistent performance from the exoskeleton 100, the friction compensation can be performed by identifying the friction coefficient of the system and creating a bidirectional adjustment of supporting torque 222 based on the motion of the person 200.

Many methods can be used to identify the friction coefficient of the system. An example of this can be moving the trunk support exoskeleton at the same velocity in the flexion and extension direction. The torque output of the system is measured during this motion. The apparatus of measurement might be integrated into the exoskeleton or, in some embodiments, may be external to the exoskeleton. This apparatus may include but is not limited to, torque sensors, force sensors, springs, etc. In some examples, an individual may wear the device and qualitatively compare the torque in the 2 directions. The controller of the exoskeleton is adapted so that the output torque of the system is the same during the flexion and extension motion. In some examples, the friction coefficient is calculated at the time of fabrication. Performing this friction compensation allows actuator 440 to provide a smaller torque during flexion and a higher torque during extension activities to compensate for the directionality of friction torque. This will further allow a consistent feeling during person 200's dynamic bending activities. In some examples, the friction coefficient may be calculated through one or more of the inputs of control system 1100 during the initialization process or during use of exoskeleton 100. This is performed as the friction in the system may increase over time.

It should be noted that friction forces may change over time as the exoskeleton 100 is being used and various components wear out, such as the first line 450, second line 456, first jacket 470, and/or second jacket 472, and wear in the transmission system. In some examples, exoskeleton 100 monitors the friction profiles over time and adjusts the friction coefficient periodically. Specifically, the friction in the first line 450 or second line 456 has an additive effect on supporting torque 222 felt by the person 200 in one direction of motion and a subtractive effect in the opposite direction of motion.

One method of determining the friction over the course of the device's life is described here. In some examples, the exoskeleton measures the amount of motion of the frame 102 or the thigh, or the first link or second link, for a known amount of support torque 222 that is commanded. As the friction in the system increases, the amount of motion of the trunk or the thigh, or the first link, or the second link will reduce. In some examples, this is performed each time the device is turned on. In some examples, the friction check may be part of an initialization process. In some examples, the initialization process may further use the motion or at least the first link, second link, or frame 102 as haptic feedback to indicate various outputs to the person 200. The friction over the course of the device's life is identified by periodically measuring the same commanded supporting torque 222.

Other methods exist to characterize this friction in the system over the course of the device's life. These methods may use inputs 1102, which might be integrated into the exoskeleton or, in some embodiments, may be external to the exoskeleton. These inputs 1102 may include, but are not limited to, torque sensors, force sensors, springs, etc. In some examples, inputs 1102 can be at least a force sensor 670 (claim 74) between the frame 102 and the person's trunk, or between the person and the first link or the person and the second link. If the force output at inputs 1102 for a commanded supporting torque 222 has decreased, the friction has increased.

In some embodiments, an individual may wear the device and qualitatively compare the torque in the 2 directions.

If the friction has increased control system 1100 automatically changes the flexion and extension support torque 222 behavior to adapt to the new friction characteristics and retain a consistent performance during flexion and extension motion throughout the exoskeleton 100's life. This may be achieved by changing the flexion and extension support torque multipliers discussed in a later section.

### Input Devices

As noted above, an exoskeleton 100 may comprise one or more user-input devices 1160 and/or one or more sensors 1170, which may be collectively referred to as input devices. Furthermore, an exoskeleton 100 or, more specifically, the communication module 1110 may be connected to various external input devices. Collectively, all of these input devices are used to monitor various aspects of the person 200 (wearing the exoskeleton 100), tasks performed by the person 200, and/or operational characteristics of the exoskeleton 100.

For example, a person 200 may use one or more user-input devices 1160 (e.g., dials 1162, switches 1164, grafical user interface (GUI) input, and the like) to modulate the amount of assistance and/or resistance provided by the exoskeleton 100, e.g., based on the load person 200 is manipulating, the amount of fatigue person 200 feels. In some examples, this assistance and/or resistance may be further updated based on various inputs received from one or more sensors 1170. For example, a set of force sensors 1172 (in the exoskeleton 100 and/or external to the exoskeleton 100, such as embedded into the force sensing gloves, force sensing shoes, etc.) may be used to estimate the weight of the carried load. In some examples, a camera 1178 may also be used to estimate the weight (e.g., from the size of the load). This estimation may be performed before the load is picked up. In the same or other examples, the camera 1178 may detect the position of the load relative to the person 200 (e.g., how far is the load from the body of the person 200, thereby increasing the supporting torque 222 if the load is further away from the body. Similarly, the supporting torque 222 may be decreased when the control system 1100 determines that the load is reduced and/or held closer to the body of the person 200. In some examples, arm posture sensors (e.g., accelerometers) and other sensors may also be used to provide additional inputs.

Additional input devices or, more specifically, sensors 1170 may be used to estimate the environment of exoskeleton 100 (and the person 200), such as noise levels (e.g., using a microphone 1180), temperature (e.g., using a temperature sensor 1174), and/or humidity (e.g., using a humidity sensor 1176). In some examples, the environmental temperature may be used to lower the supporting torque to ensure that the exoskeleton 100 does not overheat. In some examples, the person 200 may be given a warning if the environmental temperature is considered too unsafe to work, if the environmental sounds are too loud, or humidity is high. The temperature input and humidity inputs may also be used to provide the person a warning if they are outside the operating range of the exoskeleton 100 or the batteries. The microphone 1180 may further be used to take commands from person 200 to change modes or various control parameters, such as maximum supporting torque 222

As noted above, exoskeleton 100 may include a camera 1178, e.g., capable of locating the position of the hands of person 200 and/or estimating the carried load weight (e.g., from the size of this load).

In some examples, exoskeleton 100 is equipped with an electromyography (EMG) sensor for measuring the muscular effort of person 200 by using on the user's forearm, upper arm, back, and/or leg. These EMG inputs may be used to estimate the person's effort and adjust the supporting torque 222 accordingly. This is because the muscular effort of the user will increase while handling larger loads, for instance, or if they begin to fatigue.

In further examples, one or more sensors 1170 are placed on the fingertips of a person 200 to measure the external load on the hand. The fingertip sensors may include, but are not limited to, a force sensor 1172, a strain gauge 1171, a shear sensor 1173, and/or an EMG sensor 1182. By measuring the external load on the hands of person 200, the supporting torque 222 can be adjusted to provide an optimal level of support. For example, the fingertip sensors may be integrated into gloves that are worn by the person 200.

In some examples, an exoskeleton 100 comprises a pair of insoles or shoes equipped with a set of force sensors 1172, e.g., to measure the changes in the weight of the person 200, thereby estimating the weight of the carried load.

In some examples, one or more sensors 1170 comprise an accelerometer 1184, e.g., placed on the chest or hip pad of the exoskeleton 100 to detect tapping. As such, the accelerometer 1184 may also be operable as a user input device 1160. Unlike other types of user input devices 1160 (e.g., switches 1164, dials 1162, and/or touchscreens), the accelerometer 1184 may be easily interacted with while wearing gloves and/or other protective gear (e.g., associated with the use of exoskeleton 100).

In some examples, the user input device 1160 may allow the user to change modes that provide different behaviors of supporting torque 222 while extending vs flexing. For instance, in some cases, a person 200 may use the interface to turn on or off automatic transition of the exoskeleton 100 to aforementioned modes such as walking mode, walking while bending mode, asymmetric bending mode, etc. For example, input devices 1160 may be used to adjust the overall level of supportive torque 222, the state of exoskeleton 100, or any of the mentioned outputs.

A user input device 1160 may be located on the frame 102, first link 104, second link 106, trunk interface 622, belt 621, or other location of the exoskeleton 100. User input device 1160 may be configured such that it is easy for person 200 to use while wearing gloves or carrying objects. Multiple user input device 1160 may be used to change the same settings or outputs of exoskeleton 100.

The ability to change the settings of the exoskeleton 100 is not limited to the person 200 wearing the exoskeleton 100 and can be accessed by another person, e.g., using one or more external devices 1190 equipped with a phone app, a web app, or a wired user interface. Overall, one or more external devices 1190 or, more specifically, a user interface of one or more external devices 1190 may be used to adjust inputs or view outputs of the exoskeleton 100.

### Support Adjustment Parameters

Different wearers of the same exoskeleton 100 may prefer different supporting behaviors of the supportive torque 222. For such situations, a user input device 1160 may be used by the person 200 (wearing or planning to wear the exoskeleton 100) to adjust one or more parameters, e.g., the supporting torque 222. In some examples, user input device 1160 may be used to specify the level of supporting torque 222, such as with an absolute value of torque, a representative value, or a percentage value of the maximum supportive torque 222 that actuator 440 can provide.

As noted above, various examples of the user input device 1160 are within the scope, e.g., a dial 1162 (or, more specifically, a dial potentiometer), a switch 1164 (e.g., a momentary switch, an analog switch), a rotary encoder, and a linear encoder. In some examples, one or more external devices 1190 may be operable as a user input device 1160.

Furthermore, when the same exoskeleton 100 is used by different users or even the same user for different tasks, different amounts of resistance by supporting torque 222 during flexing motions and assistance by supporting torque 222 during extending motions may be desired. In some examples, when person 200 may be performing faster bending tasks, such as rapid palletizing or depalletizing, less resistance during flexion and more assistance during extension may be desired compared to a more static task, such as rebar tying, where a constant angle of bend is held by person 200. In the static tasks, a larger amount of resistance may be desired compared to the dynamic fast-bending task, as person 200 is bent to substantially the same position for an extended period of time. For some people, even a few minutes of static bending posture can become fatiguing.

In more specific examples, the supporting torque 222 for each given direction of rotation between the frame 102 and each of the first link 104 and the second link 106 can be adjusted. Specifically, the user input device 1160 may further include the ability to independently change/control the amount of supporting torque 222 during extension motions compared to the amount of supporting torque 222 during flexion motions. For each of the motions of flexion and extension, user input device 1160 may be used to specify an absolute value of torque, a representative value, and/or a percentage value of the maximum supportive torque 222 that actuator 440 can provide. For example, a person 200, when moving quickly, may require a higher level of supportive torque 222 when extending than when flexing. On the other hand, a person 200, when moving slowly, may require the same level of supportive torque 222 when extending as when flexing. Supportive torque 222 may be set to a higher, equal, or lower value during extension motions compared to during flexion motions based on the requirements of person 200. In some examples, the value of supporting torque 222 for extension motions relative to flexion motions is set as a ratio that adjusts proportionally with the overall level of supportive torque 222 setting as described previously.

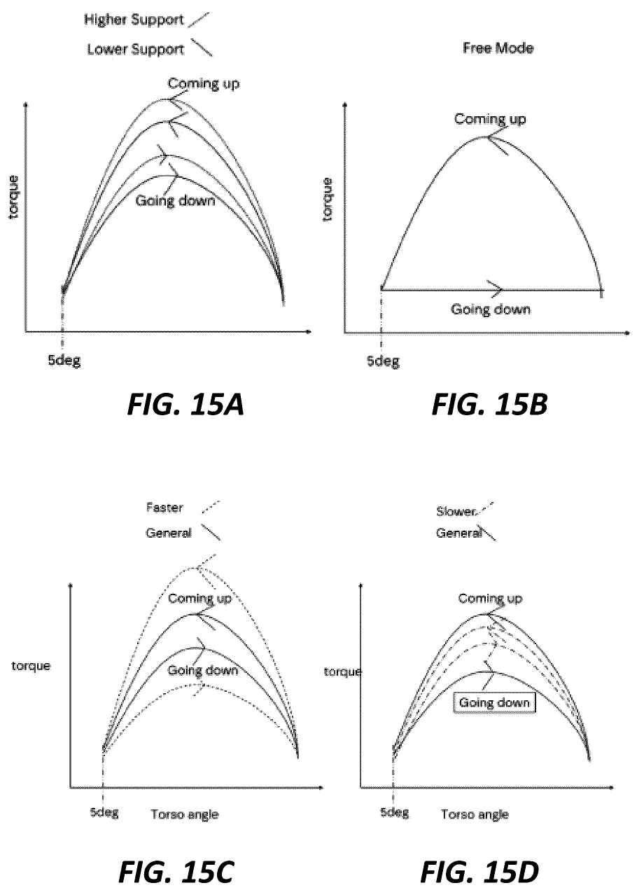

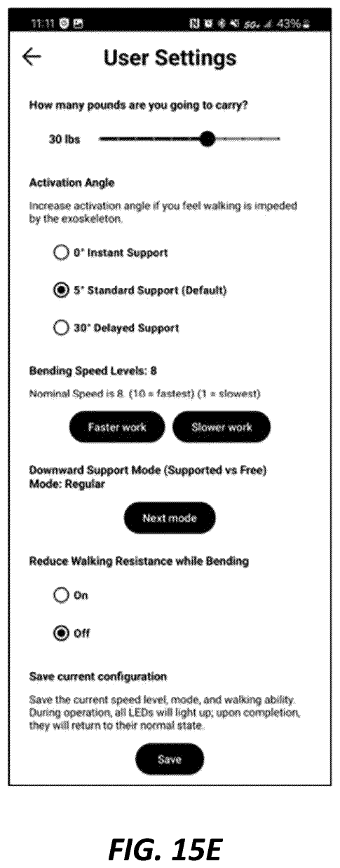

FIGS. 15A, 15B, 15C, and 15D show examples of the support torque 222 at a given speed. In these figures, the supporting torque 222 begins at a 5-degree trunk angle. In other examples, the support torque 222 may begin at other angles, not limited to 0 degrees absolute trunk angle. In some examples, a user input device 1160 may be used to adjust a multiplier that proportionally changes supporting torque 222 when person 200 is moving in the flexion and extension direction. FIG. 15A shows an embodiment, where the multiplier moves the supporting torque 222 during extension (coming up) and during flexion (going down), up when higher support is desired and lower when lower support is desired.

FIG. 15B shows an example where the supporting torque 222 provides extension assistance but provides substantially small resistance during flexion. In some examples, the person 200 may use an input device 1160 to initiate free downward support mode, where the supporting torque 222 is substantially small during all flexion activities at all speeds, while the extension activities are proportional to the speed of person 200's trunk extension.

In some examples, a supporting torque 222 has an additive effect based on the velocity of bending, i.e. when the velocity of bending is positive indicating extension motion, the supporting torque 222 is added to by an amount proportional to the speed of the extension(increases), and when the velocity of bending is negative indicating flexion, the supporting torque 222 is reduced by an amount proportional to the speed of flexion. The input device 1160 may further control a multiplier that controls the proportion of the additive effect of the velocity of bending. In some examples, the input device 1160 can be used to independently control the multiplier when the velocity is positive or negative, having the effect of independently changing the amount of supporting torque 222 magnitude the person 200 gets during extension and flexion. Thus, a first multiplier may be used when the velocity is positive, and a second multiplier may be used when the velocity is negative. In some examples, a single input parameter in input device 1160 can be changed to control both extension and flexion. FIGS. 15C and 15D show one such example, where the input device 1160 is used to adjust a multiplier proportional to the additive component of the velocity. i.e, when the multiplier is increased (as seen in FIG. 15C—“faster”), the difference between supporting torque 222 in the flexion and extension direction increases. Thus, the person 200 feels more assistance during extension (coming up) and less resistance (going down). When the multiplier gets smaller (as seen in FIG. 15D—“slower”), the difference between supporting torque 222 in the flexion and extension direction reduces. When the multiplier approaches 0, the supporting torque 222 in the extension direction and the flexion direction becomes closer in value. When the multiplier is 0, then the supporting torque 2222 in the extension direction and the flexion direction become the same.

### User Output Devices

Various user-output devices 1150 are within the scope, e.g., a display 1152, a set of lights 1153, an audio output device 1154 (e.g., speakers or piezo speakers), a tactile-interface device 1155 (e.g., vibration motor), and the like. In some examples, the actuator 440 may be used as a user-output device, e.g., by varying the supporting torque 222 in a certain manner (e.g., spiking the supporting torque 222 for a short period of time that does not interfere with the overall performance of the exoskeleton 100). More specifically, the actuator 440 may produce vibrations or tapping to provide feedback to person 200. This can take the form of the exoskeleton 100 tapping a person's thighs or a person's trunk by releasing slack in the cable and then tightening up a few times, or by rhythmically alternating the level of supporting torque 222. In some embodiments of exoskeleton 100, the frequency of control of actuator 440 can be modulated to create an auditory warning sound.

User-output devices 1150 may be triggered/controlled by the control system 1100 to inform the person 200 about various aspects of the exoskeleton operation, e.g., battery state of charge (SOC), environment temperature, person's body temperature, risk bends, and/or current/upcoming settings of supportive torque 222.

User-output devices 1150 may also inform the person 200 about various activities of the person 200, e.g., bending activity, level of fatigue, and, in some examples, provide suggestions on taking breaks. In some examples, bending activity includes but is not limited to the number of bends, angles of bends, type of bends (sagittal bending, frontal plane bending, twisting), spinal compression associated with the bend, and cumulative spinal compression associated with a bending activity. In some examples, the level of fatigue of the user can be assessed based on posture, speed, and acceleration of the person 200 in the exoskeleton 100.

In some examples, user-output devices 1150 with warnings, e.g., poor posture warnings, heavy load warnings, low battery warnings, and high temperature warnings.

Exoskeleton 100 may produce other outputs, such as the organizing of aforementioned output values designed to be used as inputs in another software or equation, such as an ergonomic program designed to estimate injury risk. For example, data of the output values of supportive torque 222 and angle between trunk frame 102 and first link 104 may be exported to estimate the exertion or risk of injury of person 200 by a separate software or equation than one integrated into exoskeleton 100. Output data may also be used to sync with general health applications, for example, to better estimate the calories burned by person 200.

Exoskeleton 100 may similarly produce outputs classified by use of a particular device or person 200, or a particular location or time, in order to organize the output data. This may be useful in detecting trends of output data by person, device, job task, or site, among other things. This data may be designed to integrate with software used by person 200 or the company of person 200 to evaluate workflows. Output data may further be used to give suggestions on maintenance and repairs of exoskeleton 100 based on usage or detected anomalies in supportive torque 222 or other outputs. Output data may further be used to give a person 200 statistics on the usage of exoskeleton 100 to gamify the use of exoskeleton 100 or the job task for which exoskeleton 100 is used.

### Display

In some examples, the display may be configured to present operational metrics of the exoskeleton 100, such as (1) settings of supportive torque 222, (2) cumulative count of bends, (3) cumulative amount of supportive torque 222, (4) periodic count or frequency of bends or supportive torque 222, (5) estimated risk of injury, based on methodologies including but not limited to the National Institute for Occupational Safety and Health (NIOSH) lifting equation, Rapid Entire Body Assessment (REBA) assessment, Rapid Upper Limb Assessment (RULA) assessment, ACGIH Lifting threshold limit value (TLV) or permutations of at least one ergonomic assessments methodology or combinations of at least two ergonomic methodologies, (6) the average bending symmetry, (7) average bending posture, (8) number of at-risk bends, and (9) comparisons with like values from other people using this specific exoskeleton 100 and/or other like exoskeletons 100.

The display 1152 may also be used to show the current and/or historical date of any inputs 1102 and/or outputs 1104 described herein. This allows person 200 or individuals supervising person 200 to monitor person 200's health and activity while in exoskeleton 100, to provide strength and posture training or job rotations as needed.

In some examples, the display 1152 (e.g., a touch screen) may also be used as one or more user-input devices 1160. For example, FIG. 15E illustrates a user interface that may be provided in the display 1152 and/or one or more external devices 1190 to control the operations of the exoskeleton 100. This user interface 1500 allows a person 200 (e.g., the wearer of the exoskeleton 100) to configure and adjust various operational parameters of the exoskeleton. The used interface provides a software-based means of modifying support parameters such as load setting, activation angle, bending speed, and support mode, without requiring direct mechanical adjustments to the exoskeleton hardware. These parameters may be transmitted to the control system 1100, stored in memory, and executed in real time to customize the exoskeleton's behavior (e.g., the supporting torque 222) according to the wearer's task and preference.

As shown in FIG. 15E, the user interface may include a load selection field enabling the person 200 to specify an expected carried load. This value may be used by the control system 1100 to determine the amount of supportive torque 222 provided by the actuator 440 during bending or lifting operations. Furthermore, the user interface may allow supplying one of the activation angle options to adjust the exoskeleton's responsiveness—such that smaller activation angles (e.g., 0°) provide instant support during trunk flexion, while larger activation angles (e.g., 30°) delay assistance until deeper bending occurs. This parameter allows the person 200 to fine-tune the timing of the supportive torque 222 to minimize interference with natural movement.

Further, the user interface may provide controls for adjusting bending speed levels, downward support modes, and walking resistance. The bending speed level determines the rate of response of the exoskeleton's actuation profile. The downward support mode defines the operational state of the exoskeleton 100. A separate toggle enables the user to reduce walking resistance while bending, thereby improving comfort and gait fluidity during locomotion. Collectively, these adjustable parameters allow for adaptive control of the supporting torque 222 based on the wearer's physical activity, environmental context, and ergonomic preference.

The user interface may also include a command to save the current configuration, ensuring that user-specific parameters such as speed, torque, and activation thresholds are retained for future sessions. During this saving operation, the exoskeleton may provide feedback through user-output devices 1150 (e.g., illumination of LEDs or a vibration pulse) to indicate successful storage of parameters. In some embodiments, the saved configuration may be automatically synchronized with external devices 1190 or a cloud-based system for tracking user performance, storing historical profiles, or optimizing future assistance algorithms.

### Computer Systems

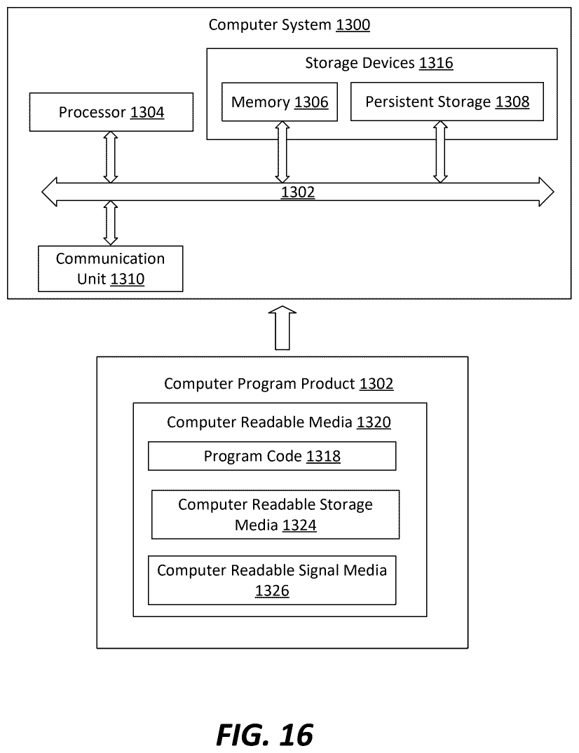

FIG. 16 illustrates a block diagram of a computing system 1300, which may be operable as or form part of the control system 1100 of the exoskeleton 100, in accordance with some examples. One or more components of the computing system 1300 may be integrated within the exoskeleton 100, for example, in the frame 102, belt 621, or trunk interface 622. The computing system 1300 is configured to execute control logic for real-time sensing, torque actuation, data acquisition, and user interface management. In various examples, computing system 1300 includes a communications framework 1302 (e.g., a bus), which provides electrical and data communications between processor unit 1304, memory 1306, persistent storage 1308, and communications unit 1310.

The processor unit 1304 may include one or more processors or microcontrollers configured to execute program instructions implementing the control algorithms, and handle communication and data storage of the exoskeleton 100. These algorithms may include the computation of supportive torque 222 based on sensor inputs, recognition of operational states such as walking, bending, or asymmetric postures, friction compensation, and adaptive response based on user-specific profiles. The processor unit 1304 may also execute closed-loop feedback routines that continuously update actuator outputs according to real-time measurements of trunk angle, joint velocity, and electromyography (EMG) signals from the person 200.

Memory 1306 and persistent storage 1308 are examples of storage devices 1316 that collectively store software, firmware, and operational data. Memory 1306 may comprise volatile storage (e.g., RAM) for real-time processing of sensor signals, while persistent storage 1308 may comprise non-volatile media (e.g., flash memory) used to retain user profiles, calibration parameters, and historical performance data. Stored instructions may include system initialization routines, adaptive control algorithms, user interface logic, and safety monitoring modules. In some embodiments, the stored data includes baseline friction coefficients, torque calibration maps, and historical sensor trends used to dynamically adjust system parameters during operation.

Communications unit 1310 provides wired or wireless connectivity between the computing system 1300 and external devices 1190, such as smartphones, tablets, or remote computing systems. Through the communications unit 1310, the exoskeleton 100 may transmit and receive operational data, firmware updates, and user interface commands. Wireless communication may occur via Bluetooth®, Wi-Fi, or cellular networks to synchronize with companion applications, cloud-based analytics platforms, or ergonomic monitoring software. The communications unit 1310 may also facilitate fleet management for multiple exoskeletons, enabling remote diagnostics, maintenance alerts, and updates to torque control profiles.

In some embodiments, the computing system 1300 further includes one or more sensor interface modules 1312 for receiving analog and digital signals from sensors 1170 (e.g., accelerometers, force sensors, EMG electrodes, temperature sensors, or cameras). These interface modules may perform pre-processing such as filtering, signal conditioning, and data fusion to provide accurate, noise-compensated input signals to the processor unit 1304. The computing system 1300 may additionally include an actuator driver interface 1314 configured to control the actuator 440, clutch 580, or other mechanical components that generate the supportive torque 222.

The techniques described herein may be implemented by processor unit 1304 executing computer-implemented instructions stored in memory 1306 or persistent storage 1308. The instructions, collectively referred to as program code 1318, may be embodied on one or more computer-readable media 1320 forming a computer program product 1322. In some embodiments, the computer-readable media 1320 may include computer-readable storage media 1324 (e.g., tangible hardware storage) and/or computer-readable signal media 1326 (e.g., transmitted electromagnetic or optical signals). The program code 1318, when executed by processor unit 1304, causes computing system 1300 to perform the control, sensing, communication, and feedback operations described herein for the exoskeleton 100.

### Conclusion

Although the foregoing concepts have been described in some detail for purposes of clarity of understanding, it will be apparent that certain changes and modifications may be practiced within the scope of the appended claims. It should be noted that there are many alternative ways of implementing processes, systems, and apparatuses. Accordingly, the present embodiments are to be considered illustrative and not restrictive.

1. An exoskeleton for reducing muscle forces in a back of a person during forward lumbar flexion, the exoskeleton comprising:
a frame configured to be coupled to a trunk of the person;
a first link configured to be coupled to a first thigh of the person; the first link rotatably coupled to the frame,
a second link configured to be coupled to a second thigh of the person, the second link is rotatably coupled to the frame;
an actuator coupled to the frame, wherein the actuator comprises:
a first element,
a second element, wherein the first element and the second element are configured to rotate or translate relative to each other to create a force or torque,
a first line having a first-line first end coupled to the first element and a first-line second end coupled to the first link, and
a second line having a second-line first end coupled to the second element and a second-line second end coupled to the second link; and
a lockout mechanism configured to selectively couple two components of exoskeleton such that the first link is prevented from rotating relative to the frame in at least one direction, wherein:
when the lockout mechanism is in an unlocked position, the lockout mechanism does not influence motion of the first link relative to the frame, and
when the lockout mechanism is in a locked position, the first link is prevented from flexing relative to the frame.

2. The exoskeleton of claim 1, wherein the lockout mechanism is configured to selectively couple the first element to the second element such that the first link and the second link are prevented from rotating relative to the frame in at least one direction when the lockout mechanism is in a locked state.

3. The exoskeleton of claim 1 wherein:
the first element further comprises a first pulley coupled to the first end of the first line,
the second element further comprises a second pulley coupled to the first end of the second line, and
the lockout mechanism is configured to selectively couple the first pulley to the second pulley such that the first link and the second link is prevented from rotating relative to the frame in at least one direction when the lockout mechanism is in a locked state.

4. The exoskeleton of claim 3, further comprising a clutch coupled between the actuator and the frame, the clutch configured to enter an engaged position and a disengaged position; wherein:
when the clutch is in an engaged position, the actuator is coupled to the frame such that when the lockout mechanism is in the locked position neither the first link nor the second link can rotate relative to the frame in a flexion direction, and
when the clutch is in a disengaged position, the actuator is rotatable relative to the frame, such that when the lockout mechanism is in the locked position, the first link is able to move in a reciprocal motion relative to the second link without a change in position of the first element relative to the second element.

5. The exoskeleton of claim 1 further comprising:
a first-link pulley configured to be coupled to or move proportionally with the first link, and
a second-link pulley configured to be coupled to or move proportionally with the second link, wherein:
the first-line second end is coupled to the first-link pulley and the second-line second end is coupled to the second-link pulley, and
the lockout mechanism is configured to selectively couple the frame to one or a combination of the first line, first link, the first pulley, or the first-link pulley.

6. The exoskeleton of claim 5, further comprising an additional lockout mechanism configured to selectively couple the frame to one or a combination of the second line, second link, the second pulley, or the second-link pulley such that the second link is prevented from rotating relative to the frame in at least one direction, wherein:
when the additional lockout mechanism is in an unlocked position, the additional lockout mechanism does not influence motion of the second link relative to the frame, and
when the additional lockout mechanism is in a locked position, the second link is prevented from flexing relative to the frame.

7. The exoskeleton of claim 6, wherein:
the lockout mechanism is configured to couple the frame to the first line, and
the additional lockout mechanism is configured to couple the frame to the second line.

8. The exoskeleton of claim 6, wherein:
the lockout mechanism is configured to couple the frame to the first link, and
the additional lockout mechanism is configured to couple the frame to the second link.

9. The exoskeleton of claim 1, wherein when the lockout mechanism is in the locked position, the lockout mechanism prevents the first link from flexing and extending relative to the frame.

10. The exoskeleton of claim 1, wherein when the lockout mechanism is in the locked position, the lockout mechanism prevents the first link from flexing relative to the frame while allowing for free extension of the first link relative to the frame.

11. The exoskeleton of claim 10, wherein the lockout mechanism is configured to support person in a sustained bent posture without use of a supporting torque generated by the actuator.

12. The exoskeleton of claim 10, further comprising a control system configured to command the lockout mechanism into a locking state.

13. The exoskeleton of claim 10, wherein the lockout mechanism is actuated by a solenoid.

14. The exoskeleton of claim 10, wherein the lockout mechanism is configured to enter a locked position when the person has remained in a bent posture for longer than a specified duration of time.

15. The exoskeleton of claim 12, wherein the control system comprises inputs of temperature of the actuator to trigger a locked state of the lockout mechanism.

16. The exoskeleton of claim 1, further comprising a passive element configured to act in series or parallel with the actuator to provide a quicker response of a supporting torque to the person, add compliance to the exoskeleton, to alter or reduce actuator torque output requirements, to improve force control, to impact absorption, to dissipate, store or release energy, or to act as a mechanical force filter, wherein:
when the person is in a forward bent position and the lockout mechanism is in an unlocked position, the actuator and the passive element generate a force or torque between the first element and the second element, thereby generating a supportive torque between the first and the second links and the frame that reduces muscle forces in the back of the person, and
when the person is in a forward bent position and the lockout mechanism is in an locked position, only the passive element generates a force or torque between the first element and the second element, thereby generating a supportive torque between the first and the second links and the frame that reduces muscle forces in the back of the person.

17. The exoskeleton of claim 16, wherein the passive element may contain springs or dampers and allow for on/off selective engagement, force adjustment, set engagement position, and engagement position adjustment.

18. The exoskeleton of claim 1, wherein the lockout mechanism is actuated manually.

19. The exoskeleton of claim 1, wherein the lockout mechanism is spring-loaded into a locked or an unlocked position.

20. The exoskeleton of claim 1, wherein the lockout mechanism comprises one or more selected from the group consisting of a ratchet, a tooth, a pin, a clamp, a brake, a cleat, a one-way bearing, and a lockable pulley.
